(19) United States
(12) Patent Application Publication
(10) Pub. No.: US 2014/0164311 A1
(43) Pub. Date: Jun. 12, 2014

(54) COMPUTING PRIORITZED GENERAL ARBITRATION RULES FOR CONFLICTING RULES

(71) Applicant: International Business Machines Corporation, Armonk, NY (US)

(72) Inventors: Ulrich M. Junker, Valbonne (FR); Olivier Lhomme, Valbonne (FR)

(73) Assignee: International Business Machines Corporation, Armonk, NY (US)

(21) Appl. No.: 14/090,262

(22) Filed: Nov. 26, 2013

(30) Foreign Application Priority Data
Dec. 12, 2012 (GB) 1222344.2

(51) Int. Cl. G06N 5/02

(52) U.S. Cl. CPC G06N 5/025
USPC 706/47

(57) ABSTRACT

A system for computing prioritized and most-general arbitration rules for prioritized rules of arbitrary forms, including condition-action rules as well as default rules. The arbitration rules override the rules that are in conflict for the cases which have conflicting decisions. An external decision-making procedure may determine a decision for the arbitration rules. If arbitration rules are themselves in conflict, the procedure computes arbitration rules of higher priority to resolve those conflicts. The result is a stack of priority layers containing the original rules as well as most-general arbitration rules. Given a set of prioritized rules, a case is considered having an applicable rule and generalizes to a family of cases with conflicting rules of highest priority for the family cases. An arbitration rule of higher priority is then generated and added to the set of prioritized rules. The procedure may be repeated until all conflicts are resolved.

### PRIORITY

This application claims priority to Great Britain Patent Application No. 1222344.2, filed Dec. 12, 2012, and all the benefits accruing therefrom under 35 U.S.C. §119, the contents of which in its entirety are herein incorporated by reference.

### BACKGROUND

This invention relates to the field of a rule management system. In particular, the invention relates to computing prioritized, general arbitration rules for conflicting rules in a rule management system.

Business Rule Management (BRM) technology relates to the area of decision-making automation in business problems such as loan approval, insurance claim processing or customer loyalty programs. A Business Rule Management System (BRMS) can be used to implement and automate rule projects. A BRMS allows rule editing in a controlled natural-like language, which makes it easy to use without specific knowledge on generating rules. Rules, such as arbitration rules, can be kept in different versions in a rule repository. A BRMS further allows the execution of the rules by a rule engine, which also performs a rule analysis for detecting conflicting rules, redundant rules, and missing rules. Another feature is rule validation by test and simulation.

None of the existing rule management approaches is able to successively resolve all the conflicts, including those that are introduced for the arbitration rules themselves. Whereas the problem of rule prioritisation and overriding has extensively been studied in the field of non-monotonic reasoning and default reasoning, the question of computing more specific rules for resolving conflicts is still outstanding. Therefore, there is a need in the art for improved rule management technologies including arbitration rules and associated systems addressing resolution of conflicting rules.

### BRIEF SUMMARY OF THE INVENTION

The invention may be embodied in a procedure or system for computing prioritized, general arbitration rules for conflicting rules. Given a set of prioritized rules, a case is considered having an applicable rule and generalizes to a family of cases with conflicting rules of highest priority for the family cases. An arbitration rule of higher priority is then generated and added to the set of prioritized rules. The procedure may be repeated until all conflicts are resolved.

The subject matter regarded as the invention is particularly pointed out and distinctly claimed in the concluding portion of the specification. The invention, both as to organization and procedure of operation, together with objects, features, and advantages thereof, may best be understood by reference to the following detailed description when read with the accompanying drawings.

### BRIEF DESCRIPTION OF THE DRAWINGS

Illustrative embodiments of the present invention will now be described, by way of example only, with reference to the following drawings in which:

FIG. 1 is a flow diagram of an example embodiment of a procedure in accordance with an embodiment of the present invention;

FIG. 2 is a graph showing an example scenario in accordance with an embodiment of the present invention;

FIGS. 3A to 3C are graphs showing layers in the example scenario of the embodiment shown in FIG. 2;

FIG. 4 is a schematic diagram illustrating a procedure in accordance with the an embodiment of present invention;

FIG. 5 is a data-flow diagram for an example embodiment of the present invention;

FIG. 6 is a block diagram of a computer system in which an embodiment of the present invention may be implemented;

FIGS. 7A to 7T show graphs showing portions of a procedure in accordance with an embodiment of the present invention;

FIG. 8 is a data-flow diagram of an aspect of a system in accordance with an embodiment of the present invention;

FIG. 9 is a data-flow diagram of an aspect of a system in accordance with an embodiment of the present invention;

FIG. 10 is a data-flow diagram of an aspect of a system in accordance with an embodiment of the present invention;

FIG. 11 is a data-flow diagram of an aspect of a system in accordance with an embodiment of the present invention;

FIG. 12 is a data-flow diagram of an aspect of a system in accordance with an embodiment of the present invention; and

FIGS. 13A and 13B are data-flow diagrams of an aspect of a system in accordance with an embodiment of the present invention.

### DETAILED DESCRIPTION OF THE DRAWINGS

Embodiments of the invention may be realized in a procedure or system for computing prioritized, general arbitration rules for conflicting rules. Given a set of prioritized rules, a case is considered having an applicable rule and generalizes to a family of cases with conflicting rules of highest priority for the family cases. An arbitration rule of higher priority is then generated and added to the set of prioritized rules. The procedure may be repeated until all conflicts are resolved.

Business Rule Management (BRM) technology relates to the area of decision-making automation in business problems such as loan approval, insurance claim processing or customer loyalty programs. A Business Rule Management System (BRMS) is implemented to work with rule projects. A BRMS allows rule editing in a controlled natural-like language, which makes it easy to use without specific knowledge on generating rules. The rules can be kept in different versions in a rule repository. A BRMS further allows the execution of the rules by a rule engine, which also performs a rule analysis for detecting conflicting rules, redundant rules, and missing rules. Another feature is rule validation by test and simulation.

Organizations such as financial institutes, insurances, sales departments, governmental agencies have to treat a multitude of cases on a daily basis and have to make decisions in a globally consistent way. Examples are decisions about acceptance or rejection of a loan request, decisions about the amount of damage of an insurance claim, decisions about sales discounts and so on. An organization does not make those decisions on an individual case-by-case basis, but for whole families of similar cases. Those generic decisions are thus valid for a whole population of cases and can be codified in the form of rules. Those rules have a condition part which checks whether the rule is applicable to the case. Furthermore, they have a conclusion or action part which makes the decision. Given a case, those rules thus determine the decision that is valid for this case. Once an organization has made the generic decisions and established the rules, it is then possible to automate the decision making for the submitted cases by applying the rules, thus enabling the treatment of a huge amount of cases in an equitable way.

This goal of decision automation imposes strong requirements on the quality of the generic decisions and thus of the rules. The rules must not be formulated on an ad-hoc basis, but comply to existing well-studied reference cases as well as to general principles such as decision consistency. In particular, the decision automation system must make the same decision for indistinguishable cases. As such it is important that there are no conflicting rules, that means rules that make conflicting decisions for some of the cases. Conflicting rules may be obtained when the generic decisions are made by multiple decision makers, when generic decisions are generalized by extending the number of cases for which they are valid, or when existing rules are modified and adapted.

As cases are characterized by multiple attributes, they can be depicted as points in a multi-dimensional space. The cases treated by a rule can be depicted as regions in such a space. When making a generic decision, the decision maker delimits a region in this multi-dimensional space and may introduce overlaps with the regions of other rules, which leads to conflicts if those rules make conflicting decisions. In order to keep the rules general enough, those overlaps are unavoidable and it is often preferable to treat the resulting conflicts in a particular way.

A decision automation system may thus have a layer of general rules and a second layer of rules that treat the conflicts among the general rules for the overlapping regions. The rules of this second layer are more specific and override the more general rules. If there remain conflicts among the rules of the second layer, it is possible to add a third layer of even more specific rules that treat the overlaps among the rules of the second layer. Hence, if there remain conflicts among the rules of a layer, then it is possible to add a further layer of more specific rules that override all the rules of the lower layers and that treat those conflicts. As those rules in higher layers treat the overlaps among rules in lower layers, they usually treat fewer cases than the rules in lower layers and it will, in normal circumstances, be possible to reach a top-most layer which no longer contains conflicting rules.

This layered approach to rule modelling has the advantages that rules can be kept as general as possible and independent of each other. Conflicts among rules are resolved by introducing more specific rules. These more specific rules serve as arbitrators between the more general rules and impose a particular treatment of the cases which have conflicting decisions under the more general rules.

Conflicts can also be resolved by modifying the original rules such that they no longer overlap. However, the modified rules will either cover irregular forms of regions in the case space which are more complex to describe and more difficult to manipulate. Or it may be necessary to divide the original rules into more specialized rules in order to partition the case space into regions of a regular form. This may significantly increase the number of rules. Overlap avoidance thus prohibits rules with most-general conditions of a regular form, whereas the layered approach keeps the rules as general and regular as possible, thus avoiding complex forms and arbitrary divisions.

Decision automation systems use rule tasks or rule priorities to represent the layers. If used properly, a rule engine will then execute most specific rules only. Given a case, a rule engine first determines the applicable rules, i.e. the rules that are valid for this case. Those rules may belong to different layers. If there are multiple rules that treat a given case, then the rule engine will consider only the top-most layer that contains rules that are applicable to the case. The engine will execute only rules in this top-most layer, thus overriding the rules in the lower layers. If a case has conflicting rules in a lower layer, but an arbitration rule in the top-most layer, the engine will only execute the arbitration rule, but not the conflicting rules.

Existing rule engines provide different mechanisms for realizing the rule overriding. Prioritized default rules execute the applicable rules layer-by-layer starting with the top-most layer. Once they have executed the applicable rules of a higher layer, all default rules that belong to lower layers and that are in conflict with the executed rules are automatically blocked. Hence, once the default rule engine has executed an arbitration rule, it will block all rules that are conflicting with the arbitration rule. In particular, it will block the conflicting rules for which the arbitration rule has been set up.

Production rules also permit a prioritisation of the rules. Similar to the default rule engine, the production rule engine will execute applicable rules of higher priority first. However, once the production rule engine has executed a rule of higher priority, it does not automatically block conflicting rules. Hence, the execution of an arbitration rule by a production rule engine will not automatically block the conflicting rules for which it has been introduced. If the execution of the arbitration rule does not make the conflicting rules inapplicable then the production rule engine will still execute the conflicting rules, meaning that the decision made by the rule executed last will win. This completely reverses the intended effect of the priorities. As a consequence, additional effort and care is needed to implement rule overriding in a production rule system. The rule author can, for example, add rule conditions that check whether the rule decision has already been made and that make the rule inapplicable in that situation. If an arbitration rule has already made the decision, the conflicting rules in lower layers will then check this and signal to the rule engine that they are not applicable. Those additional rule conditions thus provide a way to implement the rule overriding, but it should be noted that they constitute procedural control knowledge which is mixed with declarative rule conditions.

Newer production rule systems offer explicit control mechanisms in form of a rule flow to separate procedural control knowledge from declarative rule conditions. The rule flow consists of several tasks executed in a predefined order. For example, it is possible to introduce a task for each layer and to say that tasks for upper layers precede tasks for lower layers in the rule flow. The rule flow permits the check of conditions between two successive tasks. For example, if a decision has been made after executing a first task, the rule flow may check this and stop the execution of succeeding tasks if this condition has been met. This prevents the execution of rules in tasks for lower layers if rules in upper layers have already been executed. Hence, the overriding mechanism can also be implemented by an adequate rule flow in a production rule system.

Thus, modern rule engines provide ways for representing the layered rule modelling approach with more or less effort. They are able to execute rules in the top-most layer first and to override the rules in lower layers. As such they enable the usage of arbitration rules for resolving conflicts among most general rules. It is important to note that those arbitration rules should only be introduced for cases with conflicting decisions, i.e. cases which make multiple rules applicable (in the top-most layer) such that those rules have conflicting, i.e. incompatible decisions.

Other disclosures do not generate arbitration rules, but adjust priorities for some of the rules in conflict or ensure that those selected rules override the other rules. Those approaches thus put some of the original rules in higher layers and may inadvertently introduce new conflicts in those higher layers. If a rule is in conflict with another rule then resolving this conflict should affect only those cases which make both of the conflicting rules applicable. However, when a rule is moved in an upper layer, then this move affects all the cases treated by this rule and not only the cases that had conflicting decisions. Moving a rule into an upper layer thus removes conflicting decisions for some of the cases, but may introduce conflicting decisions for other cases as a side-effect. Hence, modifying the priority of a rule for resolving conflicts among rules is not a valid approach.

Even other approaches resolve conflicts between rules by specializing the conditions of some of the conflicting rules. As explained before, this will either lead to rules covering non-regular forms in the case space or to a division of the rules into multiple specialized rules in order to keep a regular form. Rules of non-regular forms are difficult to read and to manage. Dividing the rules may lead to an increase of the number of rules and this increase is higher than that resulting from the addition of arbitration rules. Moreover there may be multiple ways for subdividing the rules which may lead to an arbitrary choice of those divisions.

None of the existing approaches is able to successively resolve all the conflicts, including those that are introduced for the arbitration rules themselves. Whereas the problem of rule prioritisation and overriding has extensively been studied in the field of non-monotonic reasoning and default reasoning, the question of computing more specific rules for resolving conflicts is still outstanding.

Embodiments of the invention meet this need in a procedures and systems for computing prioritized, general arbitration rules for conflicting rules. The procedure may include generating arbitration rules resolving conflicts among original rules in the set of prioritized rules, and resolving conflicts among arbitration rules by adding additional priority layers until all conflicts are resolved. The set of prioritized rules may include original rules, any original arbitration rules, and any new arbitration rules. Generalizing to a family of cases with conflicting rules of highest priority for the family cases may include lifting the case having an applicable rule to a top-most priority layer, generalizing the case to a most-general family of cases with applicable rules, and determining if the family contains any conflict-free cases and discarding any conflict-free cases. The procedure may further include excluding any existing conflict-free cases when generating a case having an applicable rule. Rules may be condition-action rules or default rules, with fixed priorities or dynamic priorities. Rules with dynamic priorities may belong to several layers and calculating the priority of a rule depends on the case to which it is applied.

The procedure may include a first operation which computes a single arbitration rule for a set of original rules. If previously generated arbitration rules are available, then this operation takes them into account and generates a new arbitration rule which is not among the previously generated arbitration rules. A second operation iterates the computation of single arbitration rules in order to find a whole layer of arbitration rules. This layer of arbitration rules resolves all the conflicts among the original rules. A third operation repeats the generation of layers of arbitration rules to remove any conflicts among the generated arbitration rules. In each iteration, the operation may transforms the generated arbitration rules into original rules and re-invokes the second operation to compute a new layer of arbitration rules for this extended set of rules, while starting from an empty set of arbitration rules.

The operations may apply time limits to guarantee that the whole process terminates; if such a time limit is exceeded, then the procedure may not find all arbitration rules, but the procedure may guarantee that the computed rules are valid arbitration rules.

The procedure may result in a stack of priority layers containing original rules as well as most-general arbitration rules.

The procedure may consider a case having an applicable rule with treatment in a layer if some rule applicable to the case is in the layer. Generalizing to a family of cases with conflicting rules of highest priority for the family cases includes a case having top-most treatment in a layer if there is no higher layer which has a treatment for this case. A family of cases has a treatment in a layer if each case of the family has a treatment in the layer characterized by a set of logical tests. A case family has a top-touching treatment in a layer if each case of the family has a treatment in this layer and at least one case in the family has a top-most treatment in this layer, in which the top-most treatment models the fact that a rule engine selects an applicable rule in a highest priority layer.

The process of generating an arbitration rule may be carried out by an external decision making procedure. The external decision making procedure may inspect a set of cases treated by an arbitration rule and may split it, while imposing different decisions for the resulting rules.

A system for computing prioritized, general arbitration rules for conflicting rules includes a treatment generator for, given a set of prioritized rules, considering a case having an applicable rule. A family generator generalizes to a family of cases with conflicting rules of highest priority for the family cases. An arbitration rule generator generates an arbitration rule of higher priority and for adding the arbitration rule to the set of prioritized rules. The arbitration rule generator may generate arbitration rules resolving conflicts among original rules in the set of prioritized rules, as well as resolving conflicts among arbitration rules by adding additional priority layers until all conflicts are resolved.

The system may include a store of original rules and an arbitration rule store for any original arbitration rules and any new arbitration rules. The family generator may include a treatment-layer maximizer for lifting the case having an applicable rule to a top-most priority layer. A treatment-case generalizer may generalize the case to a most-general family of cases with applicable rules. A treatment-conflict checker may determine if the family contains any conflict-free cases and discard any conflict-free cases. A treatment may store any conflict-free cases in order to exclude any existing conflict-free cases when generating a case having an applicable rule.

The system may further include a system for computing an arbitration rule for carrying out a first operation computing a single arbitration rule for a set of original rules, if previously generated arbitration rules are available. This operation then takes them into account and generates a new arbitration rule which is not among the previously generated arbitration rules. A system for computing a layer of arbitration rules for carrying out performs a second operation iterating the computation of single arbitration rules in order to find a whole layer of arbitration rules, this layer of arbitration rules resolves all the conflicts among the original rules. A third operation repeats the generation of layers of arbitration rules to remove any conflicts among the generated arbitration rules. In each iteration. the operation transforms the generated arbitration rules into original rules and re-invokes the second operation to compute a new layer of arbitration rules for this extended set of rules, while starting from an empty set of arbitration rules.

The system may include time limit components and in which the operations apply time limits to guarantee that the whole process terminates. If such a time limit is exceeded, then the system will not find all arbitration rules, but the system guarantees that the computed rules are valid arbitration rules. The system may also include a decision oracle and in which generating an arbitration rule is carried out by the decision oracle in the form of an external decision making mechanism.

A computer program product may be provided for computing prioritized, general arbitration rules for conflicting rules. The computer program product includes a computer readable storage medium readable by a processing circuit. The product storing instructions for execution by the processing circuit for performing a procedure according to the first aspect of the embodiment. A computer program stored on a computer readable medium and loadable into the internal memory of a digital computer, including software code portions, when said program is run on a computer, for performing the procedure of the first aspect of the present invention. Embodiments may also be realized in a procedure or a system substantially as described with reference to the figures.

The embodiment of the invention provide the advantage of resolving substantially all conflicts among prioritized rules by generating a suitable set of arbitration rules of higher priority. They do so without modifying existing rules and thus preserve rule independence and facilitate tasks such as rule capture and rule life-cycle management.

In a particular embodiment, a procedure and system are provided for computing prioritized and most-general arbitration rules for prioritized rules of arbitrary forms, including condition-action rules as well as default rules. The arbitration rules override the rules that are in conflict for the cases which have conflicting decisions. The procedure uses an external decision-making procedure to determine a decision for the arbitration rules. If arbitration rules are themselves in conflict, the procedure computes arbitration rules of higher priority to resolve those conflicts. The result is a stack of priority layers containing the original rules as well as most-general arbitration rules.

Given a set of prioritized condition-action rules or prioritized default rules, the procedure is able to find a family of cases with conflicting rules of highest priority for the family cases and to generate an arbitration rule of higher priority. The procedure is able to generate arbitration rules with most-general conditions. If added to the rule set, this arbitration rule will then override the rules in conflict and impose its decision. Iterating the procedure will thus eventually resolve all conflicts among the original rules and among the arbitration rules supposing that no time limit is exceeded. The described procedure considers a single rule execution process and supposes that all rules in the given ruleset may be applicable in this execution process.

The procedure does not impose any restriction on the conditions and conclusions or actions of the rules. It is able to find arbitration rules for rules that differ in their scope, i.e. the number and types of the objects matched by those rules. The procedure supposes that rule priorities can be represented numerically and it is able to treat rules with dynamic priorities that depend on properties of the given case. The scope and condition of the generated arbitration rule is as general as possible, i.e. the arbitration rules match as few objects as necessary and treat as many cases with conflicting decisions as possible. The procedure guarantees that the generated arbitration rules only treat cases with conflicting decisions and will not introduce any new conflict for cases that had no conflicting decision before.

The procedure uses knowledge about incompatible actions to find conflicts among condition-action rules. It may use knowledge about incompatible conclusions to find conflicts among default rules. Furthermore, the procedure may use knowledge about defaults choices or preferences among the available options for the decision and use it to propose an action or conclusion for the generated arbitration rule. A decision maker or rule maker may review the decision imposed by the arbitration and alter it. The decision maker may also inspect the set of cases treated by the arbitration rule and split it, while imposing different decisions for the resulting rules. In particular, the splitting condition may test different attributes than that tested by the original rules.

Even if the original rules belong to a single layer, the procedure will construct a layered structuring of the rules. In a first phase, it will generate one or more arbitration rules for resolving the conflicts among the original rules. In a second phase, the system will resolve conflicts among the arbitration rules. Thus, each phase adds an additional layer until all conflicts are resolved.

The procedure thus works with a “layered space”, i.e. a stack of layers. Each layer describes the possible cases. If a case can be characterized by a finite number of attributes, then each layer describes the cases in form of a Cartesian space such that the dimensions of this space correspond to the attributes of the case. These Cartesian spaces all have the same dimensions and describe the same cases. A case appears as a point in these spaces and thus has an appearance in each layer. A rule with a fixed priority belongs to a single layer and treats the appearances of all cases in this layer to which it is applicable. A rule with a dynamic priority will calculate its priority depending on the case to which it is applied. Those rules with dynamic priorities thus belong to several layers, but they will treat only a single appearance of each case. Although a rule may treat only a single appearance of each case in a single layer, different appearances of a case in different layers may be treated by different rules. If a case has a structure and consists of multiple objects of different types, then each layer consists of a constellation of Cartesian spaces, namely one for each possible scope of the case where the scope determines the types of objects of the case. Each case belongs to the Cartesian space set up for its scope and again has multiple appearances in different layers.

A case has a treatment in a layer if some rule is applicable to the case in this layer. A “case treatment” thus is a combination of a case and a layer. A case has a top-most treatment in a layer if there is no upper layer which has a treatment for this case. Similarly, a family of cases has a treatment in a layer if each case of this family has a treatment in this layer. Finally, a case family has a top-touching treatment in a layer if each case of this family has a treatment in this layer and at least one case in the family has a top-most treatment in this layer. The top-most treatment models the fact that the rule engine selects an applicable rule in a highest layer. When generalizing the treatment of a case in a top-most layer to a treatment of a whole family of cases then it may happen that some cases of this family have applicable rules in an even higher layer. This does not represent a problem for the generation of arbitration rules (if those rules are inserted below of this even higher layer) as those arbitration rules will never be applied to those additional cases. The purpose is to have rules that are as general as possible rather than having rules that will be applied to all cases that they may treat.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

In the following detailed description, numerous specific details are set forth in order to provide a thorough understanding of the invention. However, it will be understood by those skilled in the art that the present invention may be practiced without these specific details. In other instances, well-known procedures, procedures, and components have not been described in detail so as not to obscure the present invention.

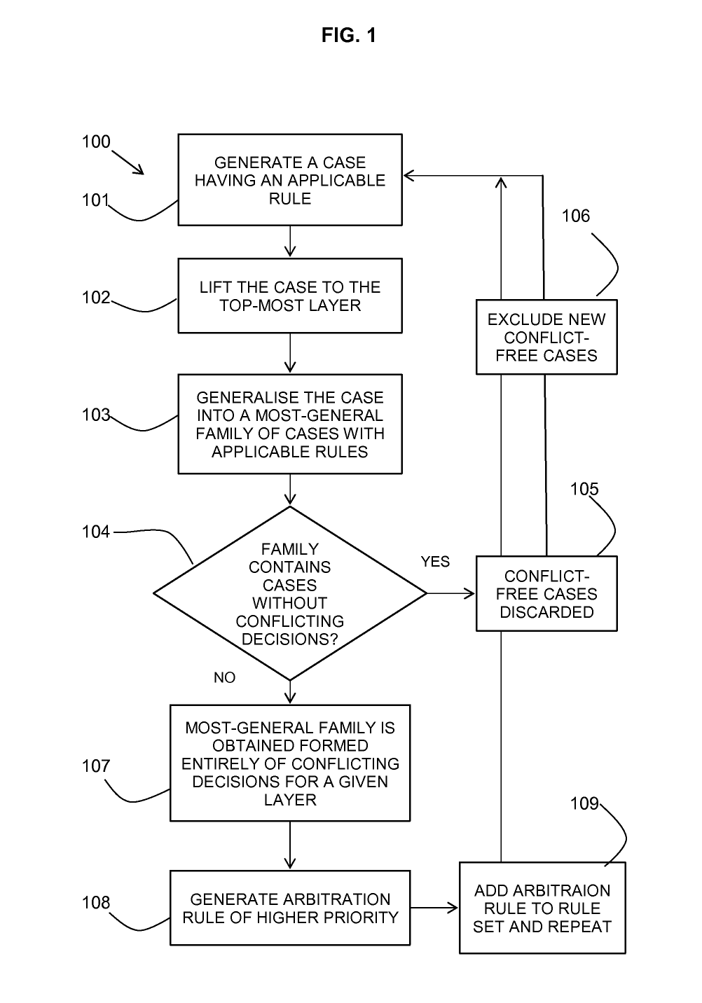

Referring to FIG. 1, a flow diagram 100 shows an embodiment of a general procedure. The procedure starts by generating 101 a case having an applicable rule taking into account existing rules, existing arbitration rules, existing discarded conflict-free cases. The procedure includes lifting 102 the case to a top-most priority layer. The case may be generalized 103 into a most-general family of cases with applicable rules.

It is determined 104 if the family contains cases without conflicting decisions. If there are cases without conflicting decisions, these cases are discarded 105 and the procedure loops with the new conflict-free cases being excluded 106 when generating a new case 101.

If it is determined 104 that if a family contains no cases without conflicting decisions, a most-general family is obtained 107 that entirely consists of cases with conflicting decisions for a given layer. The procedure generates 108 an arbitration rule for it of higher priority. The arbitration rule is added to the rules 109 and the procedure loops to generate a new case 101.

The procedure repeats the generation of arbitration rules until all conflicts have been resolved and there are no new cases to generate.

### EXAMPLE

An example scenario is now described on which further description of the procedure and system are based.

Organizations have the characteristics that they are not making decisions on a case-by-case basis, but in a generic way. For example, a financial institute may decide to attribute a certain loan type to customers up to a given loan amount and up to a given debt rate. Or a marketing department may decide to attribute a customer category of Gold to customers who are between 20 and 80 years old and who have bought articles for a value between $500 and $2000. On the one hand those generic decisions guarantee a certain level of decision consistency as cases with the same characteristics are decided in the same way. On the other hand, the generic decisions can be codified in form of rules and it is then sufficient to decide the submitted cases by applying those rules.

However, decision making on this generic level has some pitfalls that do not show up if decisions are made on a case-by-case basis. Firstly, the generic decisions have to cover each possible case, meaning that there will usually be a whole set of generic decisions which differ in the cases they are treating. Secondly, the cases have usually many characteristics meaning that the generic decisions have to cover a Cartesian space of cases where each dimension corresponds to a characteristic of the cases. Each case corresponds to a point in such a case space. A generic decision treats a whole set (or family) of cases which often has a regular form.

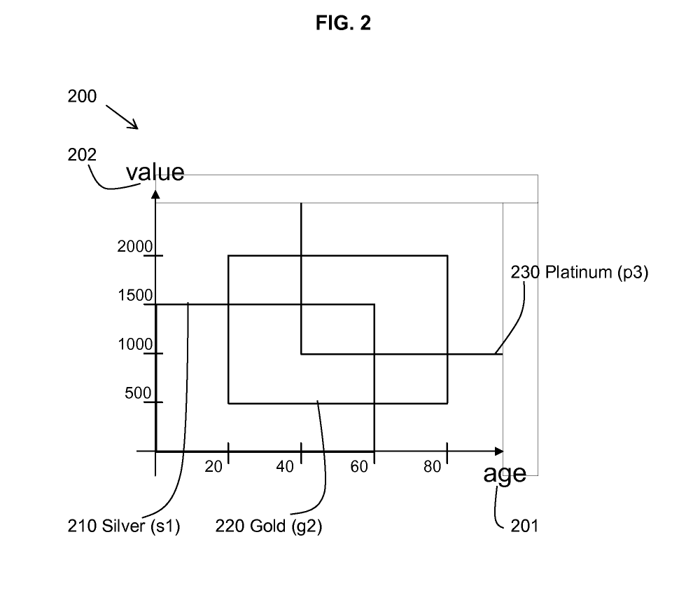

Referring to FIG. 2, a graph 200 shows a case space with the two dimensions “age” 201 and “value” 202 which corresponds to the characteristics of the given cases. As it is natural to make generic decisions that cover families of cases with a regular form, it is easy to obtain overlaps between those families. Those overlaps may be obtained if decisions for reference cases are generalized into generic decisions. For example, the decision of attributing a Silver (s1) category 210 to a 20-year-old customer who bought articles for a value of $500 may be generalized to all customers who have an age of at most 60 years and who bought articles for a value of at most $1500. The decision of attributing a Platinum (p3) category 230 to a 60-year-old customer who bought articles for a value of $2000 may be generalized to all customers who have an age of at least 40 years and who have bought articles for a value of at least $1000. FIG. 2 shows the family of cases treated by those generic decisions and it also shows the generic decision that attributes the Gold (g2) category 220 to all customers who are between 20 and 80 years old and who have bought articles for a value between $500 and $2000.

FIG. 2 shows that those three generic decisions cover overlapping regions meaning that several decisions will be made for cases in those regions. For example, a 50-year old customer who bought articles for a value of $1200 may obtain a Silver, Gold, and Platinum category. Those decisions are conflicting and cannot all be effective. Hence, the generic decisions are inconsistent for those cases. If those generic decisions are codified by rules, it will depend on secondary criteria which rule will win. Those rules may then decide the submitted cases in an arbitrary or even erratic way having repercussions on customer satisfaction, financial outcome, and so on. If generic decisions are conflicting for the same cases, they mutually annihilate themselves meaning that de-facto no decision has been made for those cases. If the generic decision making process does not guarantee this basic level of decision consistency, it looses its essential meaning.

It is therefore of primary importance to ensure that the generic decisions as well as their codifications in form of rules are consistent. There are two basic strategies to ensure consistency of the generic decisions. The first strategy avoids overlaps between generic decisions by dividing the space into overlap-free regions. Usually, it is important to keep a regular form of those regions meaning that some additional divisions need to be made. For example, the overlaps in FIG. 2 can be avoided by dividing the regions into the following overlap-free regions:

the age is at most 60 and the value is at most $499.

the age is at most 19 and the value is between $500 and $1500.

the age is between 20 and 60 and the value is between $500 and $999.

the age is between 61 and 80 and the value is between $500 and $999.

the age is between 20 and 39 and the value is between $1000 and $1500.

the age is between 40 and 60 and the value is between $1000 and $1500.

the age is between 61 and 80 and the value is between $1000 and $1500.

the age is at least 81 and the value is between $1000 and $2000.

the age is between 20 and 39 and the value is between $1501 and $2000.

the age is between 40 and 80 and the value is between $1501 and $2000.

the age is at least 40 and the value is more than $2001.

The decision maker can then make a unique decision for each of these families of cases. The resulting generic decisions are consistent.

Whereas overlap-avoidance guarantees decision consistency, it leads to generic decisions covering smaller regions and to rules that are more specialized, thus creating overhead in managing those rules. In order to keep the number of rules small, it is preferable to represent the generic decisions in form of rules that are as general as possible while keeping a regular form. For example, the regions in FIG. 2 correspond to the families of cases treated by most-general rules. As demonstrated by this example, overlaps between most-general rules cannot be avoided. Indeed, the overlaps are a consequence of making rules as general as possible. The second strategy for ensuring decision consistency therefore tolerates the overlaps, but puts the generic decisions and their rules into different priority layers. Generic decisions of a higher layer override the generic decisions in a lower layer. If a case is treated by generic decisions in different layers, only the generic decision in the highest of those layers will be eligible.

The generic decisions in the other layers will be ignored for this case. For example, the conflicts among the generic decisions shown in FIG. 2 can be solved by arbitrating decisions in a higher layer that override those conflicts.

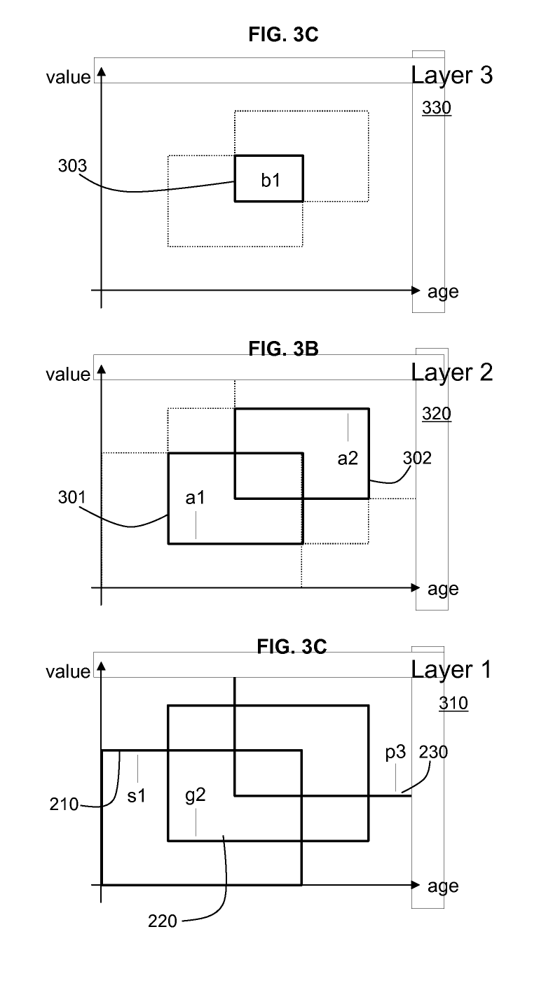

Referring to FIGS. 3A to 3C, graphs of different layers 310, 320, 330. FIG. 3A shows a layer 1 310 with the decisions 210, 220, 230 of FIG. 2. A first arbitrating decision 301 called “a1” shown in FIG. 3B, solves the conflict between the generic decisions that attribute Silver and Gold for customers aged between 20 and 60 who bought articles for a value between $500 and $1500. A second arbitrating decision 302 called “a2” shown in FIG. 3B solves the conflict between the generic decisions that attribute Gold and Platinum for customer aged between 40 and 80 who bought articles for a value between $1000 and $2000. As shown by FIG. 3B, those arbitrating decisions 301, 302 are put into a layer 2 320 which is above the layer 1 310 containing the original decisions 210, 220, 230. If those arbitrating decisions 301, 302 are in conflict, and only in this case, it is necessary to introduce a third layer 330 shown in FIG. 3C, which contains an arbitrating decision “b1” 303 for solving the conflict between the arbitrating decisions “a1” 301 and “a2” 302 for customers aged between 40 and 60 who bought articles for a value between $1000 and $1500. For example, this third layer 330 is necessary if the arbitrating decision “a1” 301 attributes the category Silver and the arbitrating decision “a2” 302 attributes the category Platinum. However, if the two arbitrating decisions “a1” 301 and “a2” 302 are not conflicting, then the arbitrating decision “b1” 303 will not be introduced.

Such a layered structure of generic decisions can be represented with more or less effort in existing formal rule languages while achieving the overriding of decisions in lower layers by decisions in upper layers. Default rules in default reasoning systems may have a built-in mechanism for rule overriding. If two rules with conflicting decisions are applicable to some case, then the default rule engine will apply only one of those default rules to the case. Once this default rule has been applied and its decision has been made, this will block all default rules making conflicting decisions. It is then sufficient to give default rules for decisions from an upper layer a higher priority than default rules for decisions from a lower layer. Default rules with a higher priority will be applied first, thus blocking the default rules in a lower layer. This mechanism of rule overriding by prioritisation has been introduced in prior disclosueres. For example, the generic decisions of FIG. 3B and 3C can be represented by the following default rules (supposing “a1” attributes Silver, “a2” attributes Platinum, “b1” attributes Gold):
default rule s1 of priority 1 if the age of the customer is at most 60 and the value of the customer is at most $1500 then the category of the customer is Silver
default rule g2 of priority 1 if the age of the customer is at least 20 and the age of the customer is at most 80 and the value of the customer is at least $500 and the value of the customer is at most $2000 then the category of the customer is Gold
default rule p3 of priority 1 if the age of the customer is at least 40 and the value of the customer is at least $1000 then the category of the customer is Platinum
default rule a1 of priority 2 if the age of the customer is at least 20 and the age of the customer is at most 60 and the value of the customer is at least $500 and the value of the customer is at most $1500 then the category of the customer is Silver
default rule a2 of priority 2 if the age of the customer is at least 40 and the age of the customer is at most 80 and the value of the customer is at least $1000 and the value of the customer is at most $2000 then the category of the customer is Platinum
default rule b1 of priority 2 if the age of the customer is at least 40 and the age of the customer is at most 60 and the value of the customer is at least $1000 and the value of the customer is at most $1500 then the category of the customer is Gold

Condition-action rules as available in production-rule systems also provide rule prioritisation, but no built-in mechanism for detecting conflicting decisions and for rule overriding. It is therefore necessary to add rule conditions to check whether the decision has already been made. Supposing that the category of the customer is undefined initially, the condition-action rules will therefore test whether this category is null in order to avoid inadvertent changes of the decisions made by rules of higher priority. Hence, the generic decisions can also be encoded by condition-action rules with adequate conditions for rule overriding:
action rule s1′ of priority 1 if the age of the customer is at most 60 and the value of the customer is at most $1500 and the category of the customer is null then set the category of the customer to Silver
action rule g2′ of priority 1 if the age of the customer is at least 20 and the age of the customer is at most 80 and the value of the customer is at least $500 and the value of the customer is at most $2000 and the category of the customer is null then set the category of the customer to Gold
action rule p1′ of priority 1 if the age of the customer is at least 40 and the value of the customer is at least $1000 and the category of the customer is null then set the category of the customer to Platinum
action rule a1′ of priority 2 if the age of the customer is at least 20 and the age of the customer is at most 60 and the value of the customer is at least $500 and the value of the customer is at most $1500 and the category of the customer is null then set the category of the customer to Silver
action rule a2′ of priority 2 if the age of the customer is at least 40 and the age of the customer is at most 80 and the value of the customer is at least $1000 and the value of the customer is at most $2000 and the category of the customer is null then set the category of the customer to Platinum

action rule b1′ of priority 3 if the age of the customer is at least 40 and the age of the customer is at most 60 and the value of the customer is at least $1000 and the value of the customer is at most $1500 and the category of the customer is null then set the category of the customer to Gold

An alternative representation of the layer structure consists in introducing a rule flow which has a rule task for each layer and which checks whether the category of the customer is null before proceeding from one task to the next task. This representation does not require to add conditions for rule overriding to the condition-action rules and provides a better separation of declarative and procedural knowledge. Hence, with an adequate effort, it is possible to achieve rule overriding also for condition-action rules.

Thus, both default rule and condition-action rule systems provide ways for representing the layered structure of decisions. However, neither default rule, nor condition-action rule systems provide procedures for generating a hierarchy of arbitration rules for resolving conflicts between given rules. Originally, only rules “s1” 210, “g2” 220, and “p3” 230 are given. If no particular analysis is carried out, the cases with conflicting decisions will not be detected and the arbitration rules “a1 301, “a2” 302, and “b1” 303 will not be introduced. As explained above, the original rule set will make arbitrary or erratic decisions for the cases with conflicting decisions. As those conflicting decisions annihilate themselves, the ruleset does not represent a meaningful and unique decision for those cases.

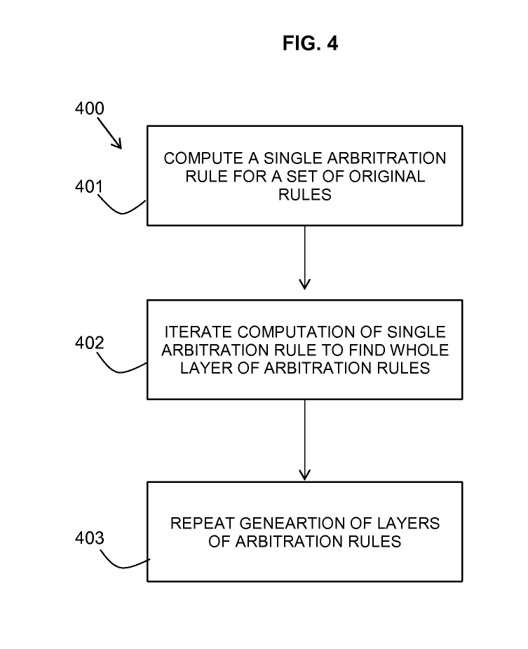

Referring to FIG. 4, a schematic diagram 400 shows a hierarchy of three operations by which the disclosed procedure and system generate the arbitration rules automatically. The lowest operation 401 is that of computing a single arbitration rule for a set of original rules. If previously generated arbitration rules are available, then this operation 401 will take them into account and generate a new arbitration rule which is not among the previously generated arbitration rules. The middle operation 402 iterates the computation of single arbitration rules in order to find a whole layer of arbitration rules. This layer of arbitration rules resolves all the conflicts among the original rules. However, there may be conflicts among the generated arbitration rules. The highest operation 403 therefore repeats the generation of layers of arbitration rules, thus guaranteeing that the resulting rulesets no longer contains a conflict. In each iteration, this operation transforms the generated arbitration rules into original rules and reinvokes the middle operation 402 to compute a new layer of arbitration rules for this extended set of rules, while starting from an empty set of arbitration rules. These operations apply time limits to guarantee that the whole process terminates. If such a time limit is exceeded, then the system will not find all arbitration rules, but the procedure guarantees that the computed rules are valid arbitration rules.

It is important to note that the original rules may already have different priorities. The procedure distinguishes these rules according to the priority layer to which they belong. When checking whether some prioritized rule is applicable to a case, the procedure does not look at the case as such, but at an appearance of the case in the priority layer of the rule. For example a case consisting of a 30 year old customer who has bought articles for a value of $1800 has an appearance in each of the three layers shown in FIGS. 3A to 3C. The first layer contains a rule, namely “g2” 220, which treats the appearance of the case in this layer, i.e. the rule is applicable to the case. The second and third layers do not contain any rule that treat the appearances of the case in those layers. If a layer contains a rule that treats the appearance of a case in this layer, then it is said that the case has a “treatment” in this layer. A treatment in this sense consists of the layer information and the case description. As a rule usually treats a whole family of cases which are characterized by a set of logical tests (such as “the age is at most 60 and the value is not at least $500”), it is convenient to consider families of treatments that belong to the same layer. A family of treatments thus consists of the layer information and the description of a family of cases. Those families are represented in form of regions in the respective layer. For example, the family of treatments of the customer who are at most 60 and who bought articles for a value of at most $1500 in layer 1 corresponds to the rectangular block for rule “s1” 210 in layer 1.

The procedure for computing a single arbitration rule starts by computing a treatment, i.e. it seeks a layer and a case such that the case is treated by this rule in some layer. Once it has found this treatment it lifts it to a top-most layer. This means the procedure explores all treatments for the same case in higher layers until it founds the top-most of those treatments. This top-most treatment overrides all lower treatments. In a third process, the procedure generalizes the treatment to a whole family of treatments. It uses the logical tests occurring in the rule conditions to describe this family. As explained before, all treatments in the family belong to the same layer, meaning that the generalization process does not alter this layer information. The generalization is limited by cases that do not have any treatment in this layer. Some of the treatments in the resulting family may be overridden by other treatments for the same cases in higher layers. By construction, the family contains at least one top-most treatment, namely the one which has been provided as input to the generalization process. A family of treatments that contains at least one top-most treatment will be called a top-touching family of treatments.

The procedure then checks whether this top-touching family of treatments contains a treatment free of conflicting decisions or whether all treatments in the family have conflicting decisions. A treatment has conflicting decisions if the layer of the treatment contains rules that are applicable to the case of the treatment and that have conflicting decisions. Two default rules have conflicting decisions if their conclusions are logically inconsistent. For example, the conclusions “the category of the customer is Gold” and “the category of the customer is Silver” cannot be both true and are thus logically inconsistent. Two condition-action rules have conflicting actions if those actions cannot be both effective in a state. Additional knowledge is necessary to detect conflicting actions. This knowledge can be given in form of constraints that state that certain actions are incompatible. For example, assigning the category of some customer to a first category value is not compatible with assigning it to a second category value if those two category values are different. According to this constraint, assigning a Silver category to some customer is in conflict with assigning a Gold category to the same customer, but not with assigning a Gold category to some different customer. A rule engine is well able to first assign a Silver category and then a Gold category to the same customer, but only the last of those actions will be effective in the resulting state. However, when assigning a Silver category to a first customer and a Gold category to a different customer, then both actions are effective in the resulting state.

If the procedure detects a treatment free of conflicts in the treatment family, then this treatment will not be subject of an arbitration rule and is discarded from the process. The procedure generalizes this treatment into a family of treatments that is free of conflicts. It then converts this family into a nogood. The procedure then starts from the beginning and regenerates a new treatment, but this time it excludes all treatments that belong to the nogood.

However, if the top-touching family of treatments does not contain any treatment free of conflicts, then the procedure has identified a conflict-full family of treatments. It can thus generate an arbitration rule for this family. It puts this arbitration rule into a layer between the treatment layer and the next higher layer occurring among the layers of the original rules. In order to determine the decision of the arbitration rule, the procedure submits one (representative) case from the treatment family to a “decision oracle” and this oracle returns a decision for this case. The decision oracle may be any decision-making procedure as known in the fields of decision analysis and decision support. Examples are linear regression/discrimination, influence diagrams, Bayesian networks, outranking procedures. The decision oracle may also include the intervention of a Human expert. Given the priority, the logical description of the cases of the treatment family, and the reported decision, the procedure builds an arbitration rule.

### System

The disclosed system consists of six principal components, namely a treatment generator, a treatment-layer maximizer, a treatment-case generalizer, a treatment-conflict checker, a treatment nogood store, and an arbitration rule generator which interact in a suitable way to generate arbitration rules.

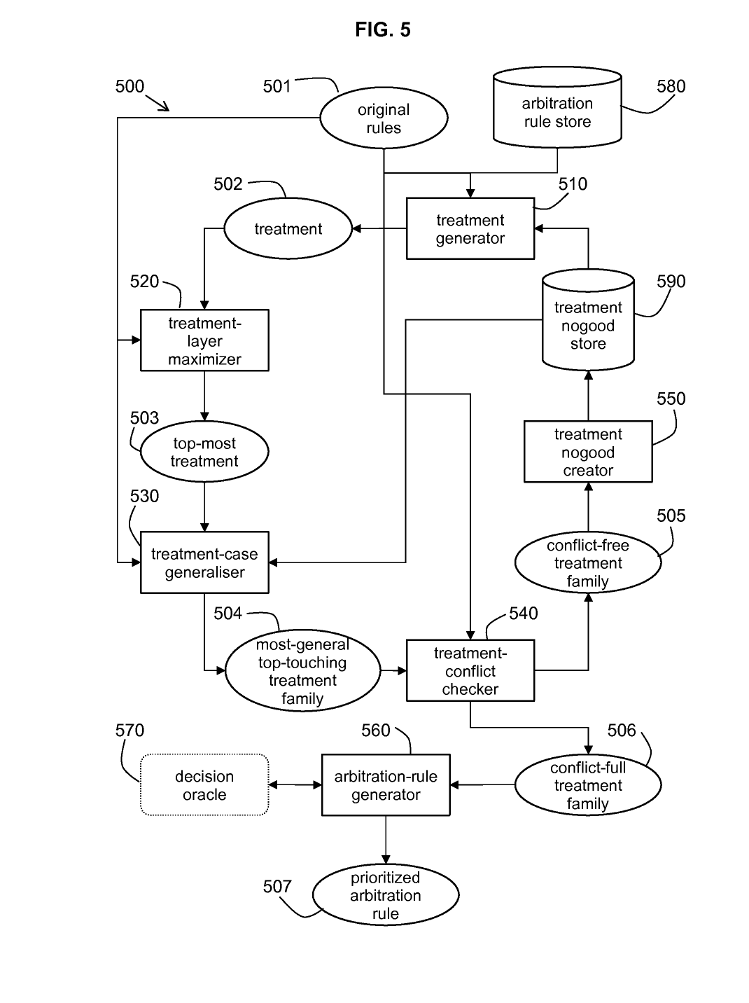

Referring to FIG. 5, a data-flow diagram 500 shows the principal components of a system for computing a single arbitration rule with data flow between them. The components are shown as rectangular boxes with inputs and outputs shown in ovals.

The six principal components are namely a treatment generator 510, a treatment-layer maximizer 520, a treatment-case generalizer 530, a treatment-conflict checker 540, a treatment nogood creator 550, and an arbitration rule generator 560. Furthermore, the arbitration rule generator 560 communicates with an external component, namely the decision oracle 570.

The whole process is controlled by “nogoods” (also referred to as conflict-free cases) generated for treatment families that have been discarded by the treatment-conflict checker 540 and which are stored in a treatment nogood store 590. Those nogoods are taken into account by the treatment generator 510 and the treatment-case generalizer 530. They ensure that the generated treatment and the generalized family of treatments do not include any of the treatments that have been discarded (exonerated) by the treatment-conflict checker or that are overridden by those discarded treatments. The system takes a set of original rules 501 as input and accesses a store of previously generated arbitration rules 580.

The treatment generator 510 receives a set of original rules 501 which can be default rules or condition-action rules and which can have numeric priorities, and uses the original rules 501, organizes them into layers according to their priorities, and seeks a treatment 502, i.e. a layer and a case such that some of the rules are applicable to this case in this layer. However, the treatment generator 510 will not generate any treatment that belongs to a nogood as determined from the treatment nogood store 590 or that is overridden by one of the previously generated arbitration rules as stored in the arbitration rule store 580. If no such treatment exists, the whole process stops with a message signalling that all conflicts have been resolved.

Otherwise, the treatment generator 510 passes the computed treatment 502 to the treatment-layer maximizer 520 which lifts it to a top-most level. The treatment-layer maximizer 520 passes its resulting top-most treatment 503 to the treatment-case generalizer 530 which computes a family of treatments on this top-most level or a “top-touching” family of treatments 504.

The treatment-conflict checker 540 determines whether the top-touching family of treatments 504 contains a treatment free of conflicting decisions, i.e. has no applicable rules with conflicting decisions on this level. If yes, then it generalizes it to a whole family 505 of treatments free of conflicting decisions. As this unproblematic family need not be considered any more, it is discarded from the arbitration process by adding a nogood to the nogood store 590. The treatment nogood creator 550 registers a nogood for this conflict-free family 505 which discards the treatments of the family as well as all treatments overridden by the family from the generation process. The treatment generator 510 takes these nogoods into account and generates a new treatment 502 that does not belong to any of the nogoods in the nogood store 590. Eventually, iterating this procedure will show that no treatment of a case has conflicting decisions or the treatment-conflict checker will signal that some family of treatments only contains treatments with conflicting decisions.

If the treatment-conflict checker 540 does not find any treatment free of conflicts within the top-touching family of treatments, it identifies this family as full of conflicts 506 and passes it to the arbitration rule generator 560.

The arbitration rule generator 560 picks a representative case from the treatment family and submits it to an external decision oracle 570, which returns a decision for this case. The arbitration rule generator 560 then returns an arbitration rule 507 built for this information.

The arbitration rule generator 560 generates an arbitration rule for this family of cases. It will put it into a layer between the treatment layer and the next upper layer of the original rules 501.

Further details of the principal components are now provided.

The treatment generator 510 takes nogoods from the treatment nogood store 590 into account and does not compute treatments that belong to some nogood. The nogoods characterize families of treatments that have previously been computed and that have been discarded. Furthermore, the treatment generator 510 takes previously generated arbitration rules from an arbitration rule store 580 into account and uses them to create additional nogoods. Those additional nogoods contain the cases with conflicting decisions for which the arbitration rules have been generated. All these nogoods together are made convex for the lower layers: if some case has been discarded for a layer it is also discarded on all lower layers. Therefore, when the treatment generator 510 returns a treatment, then neither this treatment, nor any treatment for the same case in any higher layer have been discarded or arbitrated before.

The treatment-layer maximizer 520 will then take this treatment 502 and seeks a top-most treatment for the same case. The treatment-layer maximizer 520 proceeds in several iterations and moves from one level to the next higher level in each process starting with the level of the current treatment. In each level, the treatment-layer maximizer 520 checks whether the given case has some applicable rule in this level or any higher level. If yes, the treatment-layer maximizer 520 marks this level as a candidate for a top-most treatment and continues. If no, the treatment-layer maximizer 520 stops and returns the treatment of the case in the last candidate level as result. The result is a top-most treatment for some case that has not been inspected so far. As explained, the treatment-layer maximizer 520 does not need to take the nogoods into account.

It is the treatment-layer maximizer which guarantees that the presented procedure detects conflicts among rules of highest priority for the considered cases and introduces arbitration rules only for those conflicts. In a single execution process, a rule engine will only execute a rule of highest priority among the rules applicable to the case which is given as input. If this rule application makes all necessary decisions, then no further rules will be applied, meaning that it is not necessary to resolve potential conflicts among rules of lower priority. However, if different rules may make several non-conflicting decisions and multiple rules may be applied by the engine, then the procedure and system can be adapted to resolve the conflicts among rules of any priority and to generate a larger number of arbitration rules. For this purpose, it is necessary to omit the treatment-layer maximizer and to pass a generated treatment directly from the treatment generator to the treatment-case generalizer.

The treatment-case generalizer 530 then generalizes this treatment 503 into a most-general family of treatments on the given level. It describes this family of treatments in terms of the logical tests that occur in the rules and it seeks a set of relevant tests by using consistency-based explanation techniques. The treatment-case generalizer 530 will consider a logical test as relevant if its removal from the family description includes a missing appearance in the resulting family, i.e. a case that has no applicable rule in the considered layer. It therefore constructs constraints for describing the missing appearances and uses a consistency-based explainer to find a minimal subset of the logical tests that are inconsistent when combined with these missing-appearance constraints. All tests in this minimal subset are relevant since removing any of them would result into a subset of tests that is consistent with the missing appearance constraints, meaning this resulting subset of tests describes a family which includes a missing appearance.

The treatment-case generalizer 530 may use a test-preference governor to bring the logical tests in an order that permits the generation of most-general families of treatments. Not all treatments in this resulting family will be top-most treatments, but the family will at least contain one top-most treatment, namely the one given as input to the treatment-case generalizer 530. The treatment-case generalizer 530 takes nogoods for discarded treatment families into account which do not contain any conflict. However, the treatment-case generalizer 530 ignores previously generated arbitration rules 580 and may thus generate a new arbitration rule which overlaps with those previously generated arbitration rules.

The treatment-conflict checker 540 receives this family of treatments 504 and checks whether some treatment is free of conflicting decisions. The treatment of a case in a layer has conflicting decisions if this layer contains rules with conflicting decisions that are all applicable to the case. Two default rules have conflicting decisions if their conclusions cannot all be satisfied. Two condition-action rules have conflicting decisions if their actions cannot be effective in the same state. To detect the latter, knowledge about conflicting actions is necessary, which can be given in form of constraints stating that certain actions that are mutually incompatible. If the treatment-conflict checker 540 finds a treatment free of conflicting decisions within the given family then it generalizes it to a larger family of treatments that is free of conflicting decisions. It uses consistency-based explanation techniques to find a set of relevant logical tests that describe this family. Removing any such relevant test from the family description would result in a larger family such that the larger family includes treatments with conflicting decisions. The treatment-conflict checker 540 then sends this generalized family of treatments 505 to the nogood store 590 which discards the treatments in the family by generating a nogood for it. The nogood expresses the fact that newly generated treatments must not belong to those discarded treatments.

However, if the treatment-conflict checker 540 does not detect any treatment free of conflicting decisions within the given family of treatments then it sends this family to the arbitration rule generator 560. As all treatments in the family have conflicting decisions and at least one treatment is on a top-level, the arbitration rule generator 560 creates an arbitration rule for resolving those conflicting decisions. It uses the logical tests in the description of this family to set up the condition of the arbitration rule. It puts the arbitration rule in a layer between the layer of the treatment and the next upper layer that occurs among the original rules. Finally, it uses a decision oracle 570 to produce a conclusion or action of the arbitration rule. The arbitration-rule generator 560 supplies the decision oracle 570 with one or several cases treated by the arbitration rule and receives a description of the decision from the decision oracle 570. It uses this description to build the arbitration rule. The decision oracle 570 may be any decision-making procedure as elaborated in the fields of decision analysis and decision support, including but not limited to linear regression/discrimination, influence diagrams, Bayesian networks, outranking procedures, or the intervention of a Human expert. The arbitration-rule generator 560 then returns a prioritized most-general arbitration rule 507 as its result, which resolve conflicts among the rules beneath it.

The procedure can be repeated to find arbitration rules for resolving all conflicts. For this purpose, the arbitration-rule generator 560 adds the newly generated arbitration rule to the arbitration rule store 580. Then the system for computing an arbitration rule is reinvoked. It either signals that no further case with conflicting decisions exists or it computes a new arbitration rule that may overlap with previously computed arbitration rules, but which treats at least one case with conflicting decisions not handled by those previous arbitration rules. Eventually, this process computes a layer of arbitration rules that resolves all conflicts among the original rules. As there may remain conflicts among the arbitration rules, they can be resolved by moving all the rules in the arbitration rule store 580 to the original rule set 501, thus emptying the arbitration rule store. The arbitration rules thus change their status and will be treated as original rules. The system for computing a layer of arbitration rules is then reinvoked with an extended rule set and an empty arbitration rule store. This higher-order process is repeated until no arbitration rule is found anymore. It results into an extended rule set which resolves all conflicts among the original rules and the generated arbitration rules.

The described procedure and system not only finds conflicts in a single layer, but in the surface that consists of the top-most appearances of the cases in those layers which contain rules for treating the cases. It addresses this more difficult problem by introducing maximization and generalization techniques and by a well-adapted utilization of the layer information within the different components.

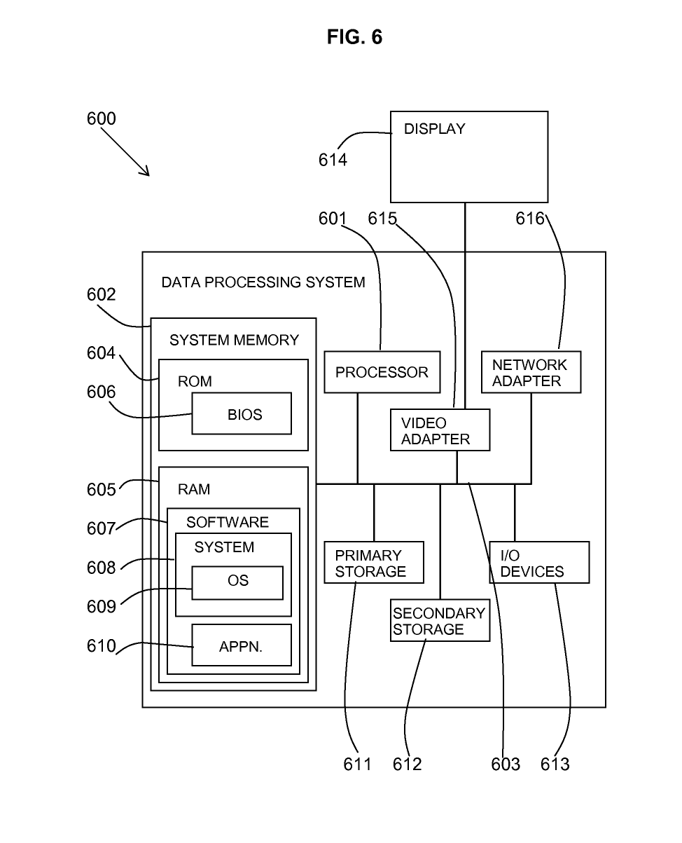

Referring to FIG. 6, an exemplary system for implementing aspects of the invention includes a data processing system 600 suitable for storing and/or executing program code including at least one processor 601 coupled directly or indirectly to memory elements through a bus system 603. The memory elements may include local memory employed during actual execution of the program code, bulk storage, and cache memories which provide temporary storage of at least some program code in order to reduce the number of times code must be retrieved from bulk storage during execution.

The memory elements may include system memory 602 in the form of read only memory (ROM) 604 and random access memory (RAM) 605. A basic input/output system (BIOS) 606 may be stored in ROM 604. System software 607 may be stored in RAM 605 including operating system software 608. Software applications 610 may also be stored in RAM 605.

The system 600 may also include a primary storage means 611 such as a magnetic hard disk drive and secondary storage means 612 such as a magnetic disc drive and an optical disc drive. The drives and their associated computer-readable media provide non-volatile storage of computer-executable instructions, data structures, program modules and other data for the system 600. Software applications may be stored on the primary and secondary storage means 611, 612 as well as the system memory 602.

The computing system 600 may operate in a networked environment using logical connections to one or more remote computers via a network adapter 616.

Input/output devices 613 may be coupled to the system either directly or through intervening I/O controllers. A user may enter commands and information into the system 600 through input devices such as a keyboard, pointing device, or other input devices (for example, microphone, joy stick, game pad, satellite dish, scanner, or the like). Output devices may include speakers, printers, etc. A display device 614 is also connected to system bus 603 via an interface, such as video adapter 615.

### Back to Example

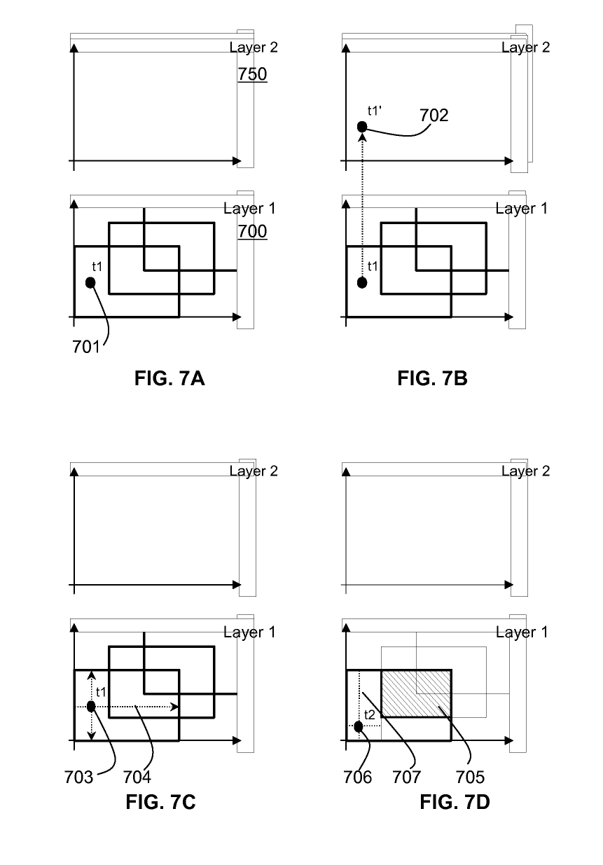

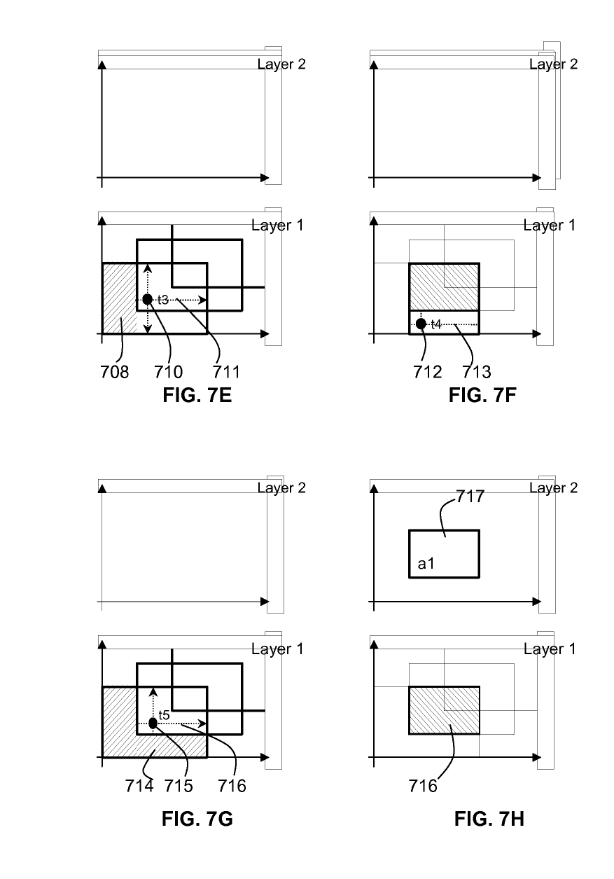

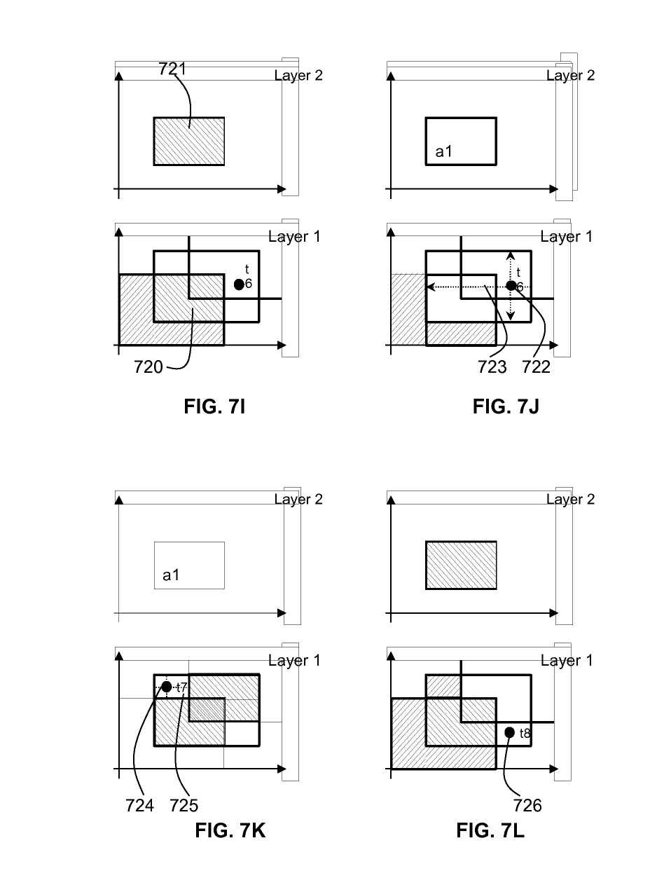

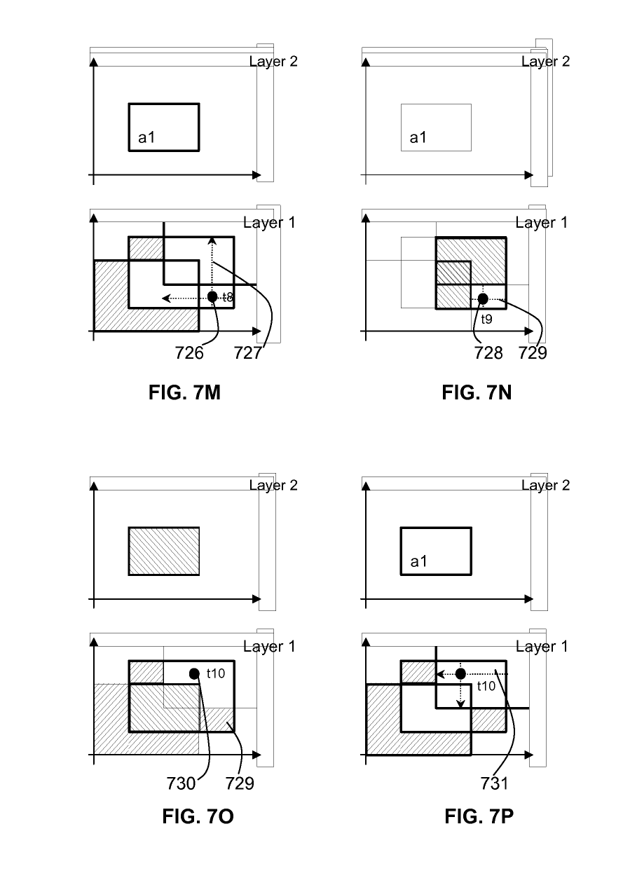

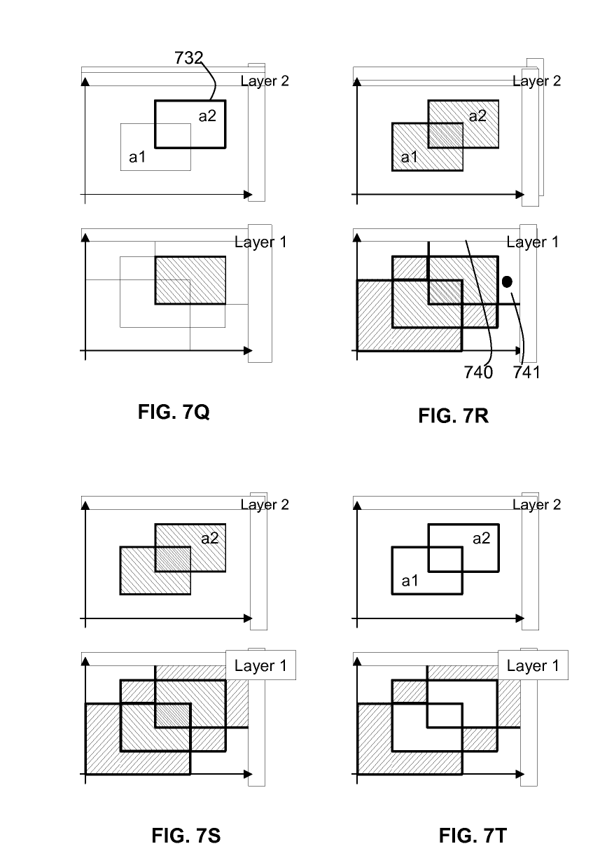

FIGS. 7A to 7T illustrate the generation of arbitration rules “a1” and “a2” in twenty increments. Each increment shows the two-dimensional case space for two layers 700, 750. The figures will explain how the layer information is exploited by the different components.

In block 1 (FIG. 7A), the treatment generator finds an applicable rule in layer 1 and generates a case that makes this rule applicable. The result is a treatment t1 701 in layer 1 for 10 year old customers who bought articles for a value of $600. In block 2 (FIG. 7B), the treatment-layer maximizer lifts this case 702 to higher layers until this results into the appearance of a case in a layer such that the case has neither a treatment in this new layer, nor in any higher layer. As only layer 1 contains rules, the treatment-layer maximizer does not find any layer above layer 1 in which the given case has a treatment. It therefore passes treatment t1 as top-most treatment to the treatment-case generalizer. In block 3 (FIG. 7C), the treatment-case generalizer generalizes 703 this treatment into a family of similar treatments. It uses the logical tests occurring in the rules to characterize those families. In block 3 (FIG. 7C), it produces the family f1 704 which contains all treatments of cases in layer 1 such that the age of the customer is at most 60 and the value of the customer is at most $1500. This family of treatments is a most-general family of regular form as adding any further treatment of a case in layer 1 would lead to a non-regular form. Such a non-regular form could no longer be described in terms of the logical tests that occur in the rules. Indeed, a family has a regular form in the sense of this invention if it can be described by a conjunction of those logical tests or their negations.

In block 4 (FIG. 7D), the treatment-conflict checker seeks a treatment in this family f1 704 such that applying the rules of layer 1 to this treatment does not result in conflicting decisions. Treatments in the hatched area 705 of block 4 have conflicting decisions. The treatment-conflict checker finds the treatment t2 706 outside this area, but inside the family f1. Treatment t2 706 corresponds to a case of a customer with an age of 10 and a value of $300. The treatment-case generalizer generalizes this treatment t2 706 into a whole family of treatments without including any element of the hatched area or any element that is outside the family f1. The result is a family f2 707 for cases where the age of the customer is less than 20 and the value of the customer is at most $1500. In block 5 (FIG. 7E), the treatment nogood creator has discarded all treatments of family f2 707. The discarded treatments are indicated by a hatched area 708 in block 5 (FIG. 7E). This closes the first iteration.

Block 5 (FIG. 7E) starts a new iteration. The treatment generator produces a new treatment, namely t3 710, which is outside the discarded area. As the treatment-layer maximizer is not able to lift it to a new level, the treatment-case generalizer generalizes t3 into a family f3 711. This includes all cases where the age of the customer is at least 20 and at most 60 and the value bought by the customer is at most $1500. In block 6 (FIG. 7F), the treatment-conflict checker detects a treatment within the family f3 711 that does not lead to conflicting decisions when the rules of layer 1 are applied to it. The treatment-conflict checker generalizes this treatment t4 712 into a family f4 713 of treatments that are free of conflicts and that belong all to the family f3 711. This concerns cases where the age is between 20 and 60 and the value is less than $500. The treatment nogood creator then discards this family by creating a nogood for it which is depicted by a second hatched area in block 7 714 (FIG. 7G). Now the treatment generator finds a new treatment t5 715 and the generalizer turns it into the treatment family f5 716 which concerns cases where the age of the customer is at least 20 and at most 60 and the value of the customer is at least $500 and at most $1500. The treatment-conflict checker is not able to find any treatment inside family f5 which is free of conflicts. In other words, when applying the rules of layer 1 to any treatment inside family f5 necessarily leads to conflicting decisions. This family full of conflicts is then passed to the arbitration rule generator. The generator picks some case from this family, say customers aged of 30 who bought for a value of $600 and passes this case to the decision oracle. The oracle may, for example, return the decision Silver, meaning that the arbitration-rule generator will return arbitration rule “a1” 717:
default rule a1 of priority 2 if the age of the customer is at least 20 and the age of the customer is at most 60 and the value of the customer is at least $500 the value of the customer is at most $1500 then the category of the customer is Silver

This rule is put into the layer 2 and block 8 (FIG. 7H) shows the zone 717 treated by this rule in layer 2. This arbitration rule overrides all rules in lower layers. Therefore, if this rule is applicable to some case, no appearance of this case in a layer below of layer 2 will be treated by a rule of this layer. Therefore, the treatment generator creates nogoods for the treatments that are overridden by the arbitration rule. They are indicated by a hatched area 720 in block 9 (FIG. 7I). For the sake of clarity, also the region corresponding to the arbitration rule “a1” in layer 2 is indicated by a hatching 721 in block 9 in order to explain that this arbitration rule does not participate in the generation of treatments. The treatment generator then produces a new treatment t6 722 outside the hatched areas and the generalizer transforms it into the treatment family f6 723. This family contains treatments in layer 1 for cases such that the age is between 20 and 80 and the value is between $500 and $2000. It is important to note that the treatment-case generalizer does not take nogoods for arbitration rules into account. It thus permits the generation of families that overlap with areas that are overridden by arbitration rules. For this reason, block 10 (FIG. 7J) does not show the hatched areas for the arbitration rules. Block 11 (FIG. 7K) shows that the treatment-conflict checker finds treatment t7 724 inside family f6 722. The checker generalizes t7 724 into a conflict-free family f7 725 which contains fewer treatments. Family f7 725 concerns cases where the age is at least 20 and less than 40 and the value is more than $1500 and at most $2000.

After discarding this conflict-free family, the treatment generator produces a treatment t8 726 which is neither in the discarded conflict-free families, nor in the area that is overridden by the arbitration rule “a1”. Treatment t8 726 concerns 70-year old customers who bought for a value of $800 as indicated in block 12 (FIG. 7L). Whereas treatment t8 726 is not overridden by the arbitration rule “a1”, the treatment-case generalizer extends t8 726 into a family f8 727 which contains cases overridden by “a1”. As shown in block 13 (FIG. 7M), this family concerns cases where the age is at least 40 and at most 80 and the value is at least $500 and at most $2000. The treatment-conflict checker finds the conflict-free treatment t9 728 within the family f8 727 in block 14 (FIG. 7N) and generalizes it into family f9 729. Family f9 729 concerns cases where the age is more than 60 and at most 80 and the value is at least $500 and at most $1000. When the treatment nogood creator has discarded family f9 729 in block 15 (FIG. 7O), the treatment generator finds a treatment t10 730 which is neither overridden by the arbitration rule, nor belongs to the discarded conflict-free families. In block 16 (FIG. 7P), the generalizer extends it into the family f10 731 which concerns customers having an age of at least 40 and of at most 80 and who bought for a value of at least $1000 and of at most $2000. In block 17 (FIG. 7Q), the treatment-conflict checker is not able to find any conflict-free treatment within this family f10. The arbitration rule generator produces a new arbitration rule “a2” 732 indicated in layer 2 of block 17, which may, for example, attribute a Platinum category based on the decision oracle's advice:
default rule a2 of priority 2 if the age of the customer is at least 40 and the age of the customer is at most 80 and the value of the customer is at least $1000 the value of the customer is at most $2000 then the category of the customer is Platinum

The process is not yet finished since there are still areas that are neither overridden by the arbitration rules, nor have been marked as conflict-free so far. These are the white areas 740, 741 enclosed by a rectangle in block 18 (FIG. 7R). Two further generation-and-check iterations are necessary to mark those areas as conflict-free as shown in block 19 (FIG. 7S). This finishes the computation of a layer of arbitration rules which solves all conflicts among the original rules.

However, the arbitration rules may have introduced new conflicts. Therefore, a new phase starts by moving the arbitration rules to the original rules and by thus emptying the store of arbitration rules. Nogoods that mark conflict-free treatments are still conflict-free in the new phase and can be kept. Block 20 (FIG. 7T) shows the case spaces in layer 1 and layer 2 after the arbitration rules have changed their statements. The treatment generator can now compute treatments in the white areas that are handled or overridden by the arbitration rules. If the treatment generator produces a treatment of layer 1 the treatment-case maximizer will now lift it to layer 2. Hence, the whole process that has been explained above will be repeated for layer 2 and eventually results into the arbitration rule “b1”, which will be put to layer 3 as shown in FIG. 3C:
default rule b1 of priority 3 if the age of the customer is at least 40 and the age of the customer is at most 60 and the value of the customer is at least $1000 the value of the customer is at most $1500 then the category of the customer is Gold

Once this rule has been generated the treatment generator will not find any treatment any more that is outside the discarded areas and that is not overridden by this arbitration rule. Hence, the second phase stops. The third phase will not produce any further arbitration rule since layer 3 only contains a single rule. Hence, the process stops with six rules, namely the three original rules “s1”, “g2”, “p3” and the generated rules “a1”, “a2”, “b1”. This set of rules does not contain any top-most treatment with conflicting decisions.

This scenario shows how the components of the system for computing arbitration rules are taking the layer information into account. The described procedure introduces layer-oriented versions of constraint graphs. A layer-oriented ruleset applicability graph describes the treatments of the cases, i.e. the appearances of the cases in those layers that contain rules that are applicable to the cases. A layer-oriented ruleset implication graph describes the decisions that the rules are making for the appearance of a case in a layer. These constraint graphs represent this information in a compact logical form. For the sake of brevity, the following discussion only describes the logical statements represented by those constraint graphs and does not include detailed figures of those constraint graphs. The constraint graphs themselves consist of graph nodes for all sub-expressions of those logical statements. The node of each such expression is connected to the nodes of its direct sub-expressions. The layer-oriented constraint graphs use a specific node which represents a numeric priority variable named “the selected layer”. This node describes the layer from which a rule will be selected. The fact that a rule is applicable in a layer will be modelled by a constraint that fixes the variable “the selected layer” to the priority of the rule. That fact that a case has a treatment in a layer is modelled in a similar way by fixing this variable to the priority of this layer. The fact that a nogood discards all treatments in its layer and all lower layers is modelled by fixing the upper bound of the variable “the selected layer” to the priority of the nogood layer. For example, the nogoods from block 7 (FIG. 7G) are represented by the following constraints:

Nogood 1: one of the following conditions is false:
the selected layer is at most 1
the age of Customer1 is less than 20
the value of Customer1 is at most $1500

Nogood 2: one of the following conditions is false:
the selected layer is at most 1
the age of Customer1 is at least 20
the age of Customer1 is at most 60
the value of Customer1 is less than $500

Hence a treatment satisfies a nogood if the case of the treatment does not belong to the discarded cases or the layer of the treatment is above the layer of the nogood.

### Data-Flows of Main Components Using Example

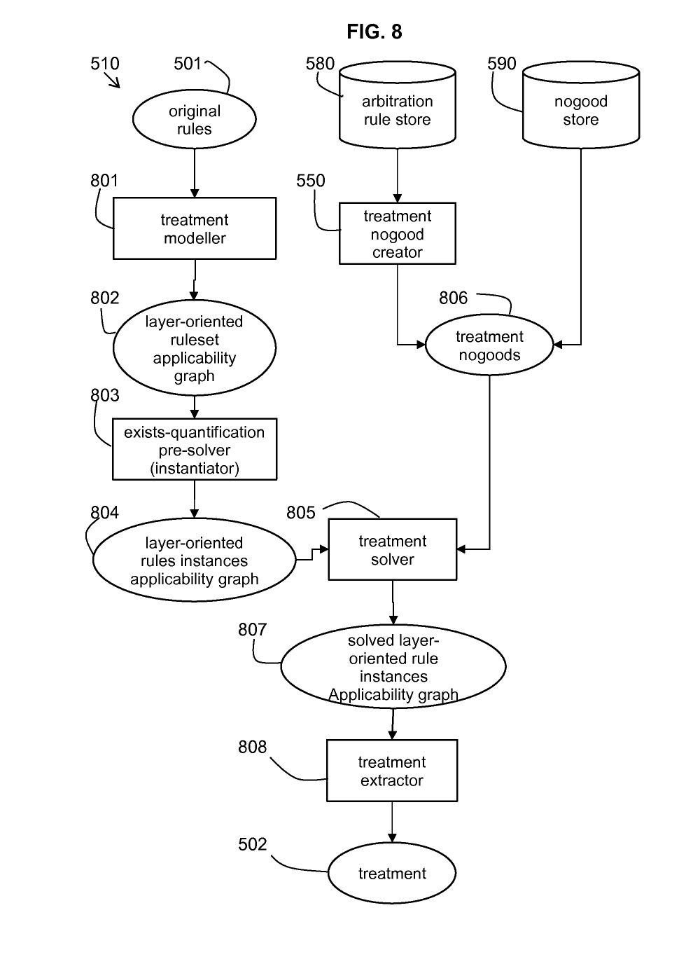

FIGS. 8 to 13A-B show data-flow diagrams of each of the main components of the system using the given example for additional explanation. Component introduced in FIG. 5 will keep the same reference numbers.

FIG. 8 shows a data-flow diagram of the treatment generator 510. It receives a set of original rules 501 and accesses an arbitration rule store 580 and a treatment nogood store 590. The treatment generator 510 uses a treatment modeller 801 to construct a layer-oriented rule set applicability graph 802. This constraint graph describes the treatments of the cases, i.e. the appearances of the cases in those layers that contain rules that are applicable to the cases. It takes the layer information into account. For the three rules “s1”, “g2”, and “p3”, this constraint graph represents the following logical constraint which describes the treatments of the rules in a compact form:

one of the following conditions is true:
there exists a customer ?x such that the selected priority is equal to 1 and the age of ?x is at most 60 and the value of ?x is at most $1500
there exists a customer ?x such that the selected priority is equal to 1 and the age of ?x is at least 20 and the age of the ?x is at most 80 and the value of ?x is at least $500 and the value of ?x is at most $2000
there exists a customer ?x such that the selected priority is equal to 1 and the age of ?x is at least 40 and the value of ?x is at least $1000.

The exists-quantification presolver 803 instantiates this logical constraint for a well-chosen set of objects. A case can have multiple objects, for example hundreds of customer objects, but each rule is only applied to a few of those objects. The rules s1, g2, p3 of the example are applied to a single customer object. If there are a hundred customer objects, each rule will have hundred rule instances, namely one for each of the customer objects. As conflicts between rules only involve two rules instances, it is sufficient to choose as many objects as necessary to create two instances of each rule, but not more. The rules of the considered example match a single object of type customer. Therefore it is sufficient to instantiate the logical constraint for at most two objects for type customer. In the following, the results obtained by using a single object “Customer1” of type Customer are explained. When adding a second object “Customer2” of type customer, no additional conflicts will be detected as two rules of the example can only be in conflict if they are making conflicting decisions for the same customer object. The result of the instantiation of variable ?x by object “Customer1” is a layer-oriented rules instances applicability graph 804:

one of the following conditions is true:
Customer1 is a customer and the selected priority is equal to 1 and the age of Customer1 is at most 60 and the value of Customer1 is at most $1500
Customer1 is a customer and the selected priority is equal to 1 and the age of Customer1 is at least 20 and the age of Customer1 is at most 80 and the value of Customer1 is at least $500 and the value of Customer1 is at most $2000
Customer1 is a customer and the selected priority is equal to 1 and the age of Customer1 is at least 40 and the value of Customer1 is at least $1000.

Before passing this graph to a treatment solver 805, the treatment generator includes a treatment nogood creator 550 which creates treatment nogoods 806 for given arbitration rules. The arbitration rules override any treatment in lower layers. Hence, the treatments of the arbitration rules as well as those in lower layers are discarded. For example, arbitration rule “a1” will lead to the following nogood, which will be instantiated for Customer1:

Nogood for “a1”: for each customer ?x one of the following condition is false:
the selected priority is at most 2
the age of the ?x is at least 20
the age of the ?x is at most 60
the value of the ?x is at least $500
the value of the ?x is at most $1500

The treatment solver 805 seeks a labelling of the layer-oriented rule instances applicability graph and constraint graphs for all available nogoods. The constraint graphs have nodes for all sub-expressions and the solver seeks a value for this node that corresponds to the type of the node. It will choose truth values for propositional nodes, numeric values for numeric nodes, and symbolic values for nodes representing objects. In particular, it chooses a numeric value for the variable “the selected priority”, thus fixing the layer of the resulting treatment. If the treatment solver does not find a labelling that respects the semantics of the graph operations and that labels the root nodes of the given constraint graphs with “true”, then the system for computing an arbitration rule stops and signals that all conflicts have been resolved. In all other cases, the treatment solver has found a treatment that is outside the discarded area. A treatment extractor 808 extracts a description of this treatment from the solved layer-oriented rule instances applicability graph 807. This description consists of the attribute values of the objects as well as the priority:

Treatment 502 t1:
the selected priority is 1
the age of Customer1 is 30
the value of Customer1 is $600

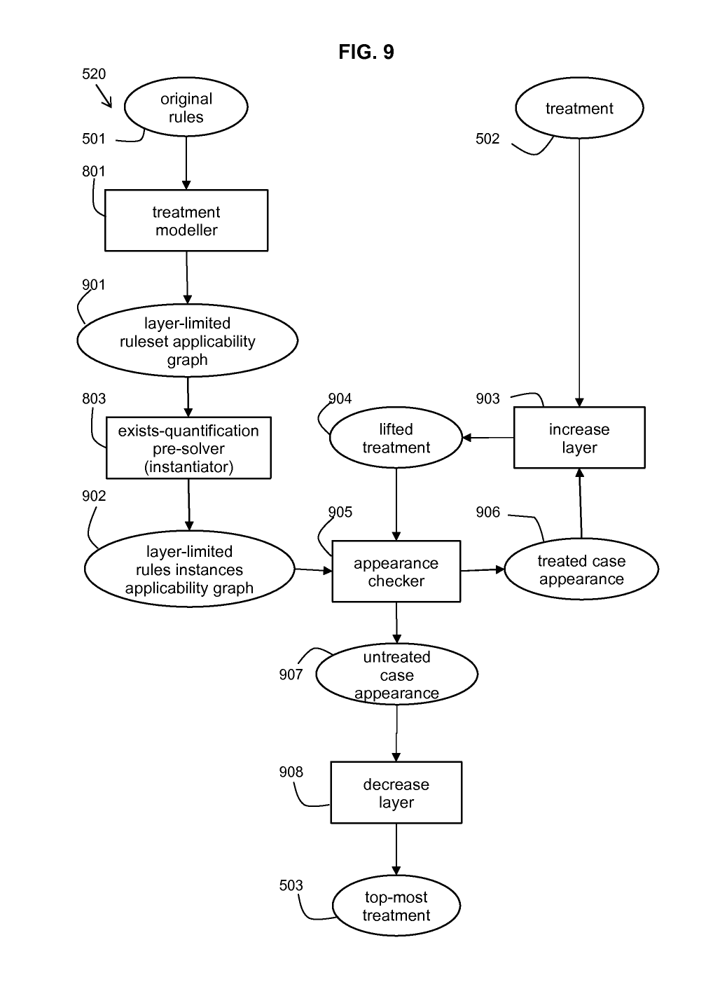

The treatment generator then passes this treatment to the treatment-layer maximizer 520 shown in FIG. 9, which seeks a top-most treatment for the same case. The treatment-layer maximizer 520 proceeds in several iterations and moves from one layer to the next higher layer in each procedure starting with the layer of the current treatment. In each layer, the treatment-layer maximizer 520 checks whether the given case has some applicable rule in this layer or any higher layer. If yes, the treatment-layer maximizer 520 continues and increases the layer again. If no, the treatment-layer maximizer 520 stops and decreases the current layer to its preceding value. It returns the treatment of the case in this last candidate level as result. The result is thus a top-most treatment for some case that has not been inspected so far.

The treatment-layer maximizer 520 builds a layer-limited rule applicability graph 901 to check whether a case has a treatment in the given layer or in any higher layer. It therefore uses constraints that check whether the selected priority is smaller or equal to a priority of a rule. Hence, the layer-limited rule applicability graph 901 has the following form for rules “s1”, “g2”, “p3”:

one of the following conditions is true:
there exists a customer ?x such that the selected priority is at most 1 and the age of ?x is at most 60 and the value of ?x is at most $1500
there exists a customer ?x such that the selected priority is at most 1 and the age of ?x is at least 20 and the age of ?x is at most 80 and the value of ?x is at least $500 and the value of ?x is at most $2000
there exists a customer ?x such that the selected priority is at most 1 and the age of ?x is at least 40 and the value of ?x is at least $1000.

An exists-quantification presolver 803 instantiates this constraint graph for a well-chosen set of objects such as the one containing object Customer1 of type Customer. The result is a layer-limited rule instances applicability graph 902:

one of the following conditions is true:
Customer1 is a customer and the selected priority is at most 1 and the age of Customer1 is at most 60 and the value of Customer1 is at most $1500
Customer1 is a customer and the selected priority is at most 1 and the age of Customer1 is at least 20 and the age of Customer1 is at most 80 and the value of Customer1 is at least $500 and the value of Customer1 is at most $2000
Customer1 is a customer and the selected priority is at most 1 and the age of Customer1 is at least 40 and the value of Customer1 is at least $1000.

Given the appearance of a case in a layer, an appearance checker 905 then determines whether this case has a treatment in this layer or a higher layer by labelling the layer-oriented rule instances applicability graph with the values from the case description. Furthermore it labels the variable “the selected layer” with the priority of the given layer. Then the appearance checker 905 extends this labelling to a complete graph labelling according to the semantics of the graph nodes. If this labels the root node with “true”, then the case has a treatment in the given layer or a higher layer. Hence, the appearance checker 905 has found a treated case appearance 906 and sends it to an increase layer component 903 which provides a lifted treatment 904. This lifted treatment is sent back to the appearance checker and the procedure is repeated until no rule is applicable to the case in the given layer or a higher layer. This untreated case appearance 907 is sent to a decrease layer component 908, which sets the layer to its previous value in order to obtain a top-most treatment 503. The treatment-layer maximizer 520 sends the resulting top-most treatment to the treatment-case generalizer.

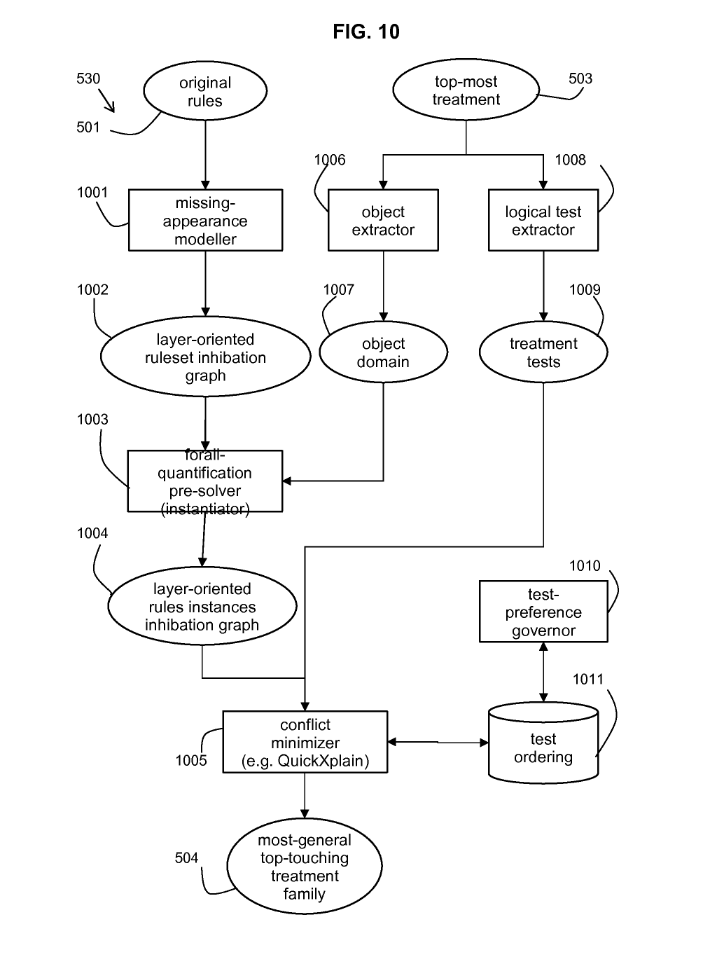

The treatment-case generalizer 530 then extends the top-most treatment 503 into a most-general family of treatments 504 on the given level. As shown in FIG. 10, it describes this family of treatments in terms of the logical treatment tests 1009 that occur in the rule. A logical test extractor 1008 checks for each logical test occurring in the rules whether the given treatment satisfies or violates the test. In the first case, it selects the test and in the second case it selects the negation of the test. Furthermore, it adds a constraint setting the selected priority to the priority of the layer of the given treatment. For example, this will result into the following tests for treatment t1:
the selected priority is equal to 1
Customer1 is a customer
the age of Customer1 is at most 60
the value of Customer1 is at most $1500
the age of Customer1 is at least 20
the age of Customer1 is at most 80
the value of Customer1 is at least $500
the value of Customer1 is at most $2000
the age of Customer1 is not at least 40
the value of Customer1 is not at least $1000.

The treatment-case generalizer 530 then seeks a subset of relevant tests by using consistency-based explanation techniques. The treatment-case generalizer 530 will consider a logical test as relevant if its removal from the family description introduces a missing appearance of a case in the resulting family, i.e. a case that has no applicable rule in the considered layer. The treatment-case generalizer 530 uses a missing-appearance modeller 1001, which provides a compact representation of the missing appearances of cases. For this purpose, the missing-appearance modeller 1001 constructs a layer-oriented ruleset inhibition graph 1002 which describes the appearances of cases which make all rules of their respective layer inapplicable. This graph has constraints fixing the variable “the selected layer” to the respective rule priorities. In the example, the following layer-oriented ruleset inhibition graph is obtained:

all of the following conditions are true:
for all customer ?x if the selected priority is equal to 1 then the age of ?x is more than 60 or the value of ?x is more than $1500
for all customer ?x if the selected priority is equal to 1 then the age of ?x is less than 20 or the age of the ?x is more than 80 or the value of ?x is less than $500 or the value of ?x is more than $2000
for all customer ?x if the selected priority is equal to 1 then the age of ?x is less than 40 and the value of ?x is less than $1000.

These quantified constraints need only be applied to the objects occurring in the given top-most treatment. An object extractor 1006 determines the objects occurring in the description of the top-most treatment and constructs an object domain 1007 that contains those objects. In the considered example, the object domain consists of a single element, namely the customer object “Customer1”. A for all-quantification presolver 1003 uses this object domain to replace each quantified constraint by a conjunction of instantiated constraints. This results into a layer-oriented rules instances inhibition graph 1004:

all of the following conditions are true:
if Customer1 is a customer and the selected priority is equal to 1 then the age of Customer1 is more than 60 or the value of Customer1 is more than $1500
if Customer1 is a customer and the selected priority is equal to 1 then the age of Customer1 is less than 20 or the age of the Customer1 is more than 80 or the value of Customer1 is less than $500 or the value of Customer1 is more than $2000
if Customer1 is a customer and the selected priority is equal to 1 then the age of Customer1 is less than 40 and the value of Customer1 is less than $1000.

If there is a case appearance that satisfies the constraints of this layer-oriented ruleset inhibition graph 1002, then this case appearance makes all the rules of its layer inapplicable, meaning that it corresponds to a missing appearance of the case in this layer. If this case appearance additionally satisfies the logical tests of a candidate subset, then this candidate subset describes a family that includes a missing appearance, meaning that it is too large. However, if there is no case appearance that satisfies both the constraints of the layer-oriented ruleset inhibition graph 1002 and the logical tests of a candidate subset, then this candidate subset describes a family of treatments.

The treatment-case generalizer furthermore takes nogoods from the treatment nogood store 590 into account as the generalized family of treatments must not include any of the conflict-free treatments which have been discarded from the process. If a candidate family included such a discarded conflict-free treatment, then the candidate family would be too large. Hence, discarded conflict-free treatment families impact the generalization process in the same way as the missing appearances. A candidate family will be too large as soon as it includes any treatment in a discarded conflict-free family or any missing appearance of a case. To check this, the treatment-case generalizer builds a disjunction of the layer-oriented rules instances inhibition graph and of all the descriptions of the discarded conflict-free families. For example, the discarded families in block 7 (FIG. 7G) are described by the following constraints:

Discarded family 1: all of the following conditions are true:
the selected layer is at most 1
the age of Customer1 is less than 20
the value of Customer1 is at most $1500

Discarded family 2: all of the following conditions are true:
the selected layer is at most 1
the age of Customer1 is at least 20
the age of Customer1 is at most 60
the value of Customer1 is less than $500

The treatment-case generalizer computes those discarded family descriptions by negating the nogoods from the treatment nogood store 590.

A conflict minimizer 1005 then uses the disjunction of the layer-oriented rules instances inhibition graph 1004 and of the descriptions of the discarded conflict-free families to compute a minimal subset of the logical treatment tests 1009 while avoiding an overgeneralization. In this way, the conflict minimizer 1005 takes nogoods from the nogood store into account in order to avoid that the resulting family of treatments includes treatments that have been marked as conflict-free. However, the treatment-case generalizer 530 ignores previously generated arbitration rules and may thus produce a treatment family which overlaps with those previously generated arbitration rules. The result of the conflict-minimization is a subset of relevant tests that characterizes a family of treatments. At least one treatment in this family is a top-most treatment 503, namely the one given as input to the treatment-case generalizer 530.

The treatment-case generalizer uses a test-preference governor 1010 to bring the logical tests in an order that permits the generation of most-general families of treatments. As more general tests may augment more specific tests, more general tests should precede more specific tests in this ordering. This test-preference governor 1010 computes this test ordering 1011 and provides it as input to the conflict minimizer 1005. Hence, if this test-preference governor 1010 is used then the resulting family of treatments is a most-general family expressible in terms of the logical tests of the rules.

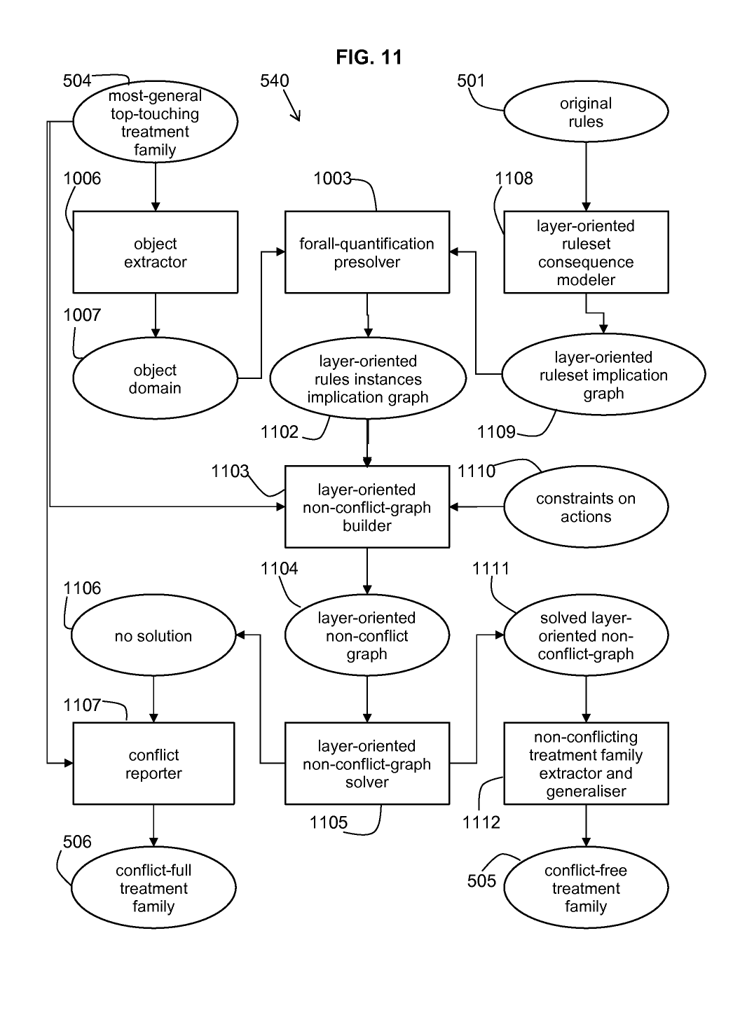

Referring to FIG. 11, the treatment-conflict checker 540 receives this most-general family of treatments 504 and checks whether some treatment is free of conflicting decisions. The treatment of a case in a layer has conflicting decisions if this layer contains rules with conflicting decisions that are all applicable to the case. As shown in FIG. 11, the treatment-conflict checker 540 uses a layer-oriented ruleset consequence modeller 1108 to build a layer-oriented ruleset implication graph 1109. This constraint graph describes the decisions made by the rules of the given layer depending on the given case. For the rules “s1”, “p2”, and “g3”, the following constraint graph is obtained:

all of the following conditions are true:
for all customer ?x if the selected priority is equal to 1 and the age of ?x is at most 60 and the value of ?x is at most $1500 then the category of ?x is equal to Silver.
for all customer ?x if the selected priority is equal to 1 and the age of ?x is at least 20 and the age of ?x is at most 80 and the value of ?x is at least $500 and the value of ?x is at most $2000 then the category of ?x is equal to Gold.
for all customer ?x if the selected priority is equal to 1 and the age of ?x is at least 40 and the value of ?x is at least $1000 then the category of ?x is equal to Platinum.

An object extractor 1006 extracts all objects from the description of the given treatment family and passes it to a forall-quantification presolver 1003, which instantiates the layer-oriented ruleset implication graph 1109. The result is a layer-oriented rule instances implication graph 1102. The example family contains a single object, namely “Customer1”, which results into the following instance implication graph:

all of the following conditions are true:
if Customer1 is a customer and the selected priority is equal to 1 and the age of Customer1 is at most 60 and the value of Customer1 is at most $1500 then the category of Customer1 is equal to Silver.
if Customer1 is a customer and the selected priority is equal to 1 and the age of Customer1 is at least 20 and the age of Customer1 is at most 80 and the value of the Customer1 is at least $500 and the value of Customer1 is at most $2000 then the category of Customer1 is equal to Gold.
if Customer1 is a customer and the selected priority is equal to 1 and the age of Customer1 is at least 40 and the value of Customer1 is at least $1000 then the category of Customer1 is equal to Platinum.

The treatment-conflict checker 540 uses a layer-oriented non-conflict graph builder 1103 to construct a layer-oriented non-conflict graph 1104. If the original rules 501 are default rules, then this constraint graph is simply a conjunction of the description of the treatment family and the layer-oriented rule instances implication graph. Two default rules have conflicting decisions as soon as their conclusions cannot all be all satisfied. Hence, no additional knowledge is necessary to detect those conflicting decisions. However, if the original rules 501 are condition-action rules then two rules have conflicting decisions if their actions cannot be effective in the same state. To detect the latter, additional knowledge about conflicting actions is necessary. This knowledge may have the form of constraints stating which actions are incompatible. An example is an incompatibility constraint stating that assigning the category of some customer to a first category value is not compatible with assigning it to a second category value if those two category values are different. The layer-oriented non-conflict graph builder 1103 takes this knowledge into account and adds constraints 1110 between incompatible actions to the layer-oriented non-conflict graph 1104.

A layer-oriented non-conflict graph solver 1105 then seeks a labelling of this constraint graph that respects the graph operations and that labels the root node with “true”. If it does not find a solution 1106 it goes to a conflict reporter 1107. If it finds a solution 1111, then it has found a treatment free of conflicting decisions. A conflict-free treatment family generalizer 1112 then extracts this treatment and generalizes into a whole family of treatments 505 that is free of conflicting decisions and that belongs to the given top-touching treatment family. As the treatment-case generalizer, this generalizer uses consistency-based explanation techniques to find a set of relevant logical tests that describe this family. This includes logical tests occurring in the rule condition as well as tests involving the rule conclusion or action. Removing any such relevant test from the family description would result in a larger family such that the larger family includes treatments with conflicting decisions or treatments outside the top-touching family. Details of the generalizer can be understood from the descriptions given above. The treatment-conflict checker 540 then sends this generalized family of treatments to the nogood store which discards the treatments of this family and all treatments that are below them by generating a nogood.

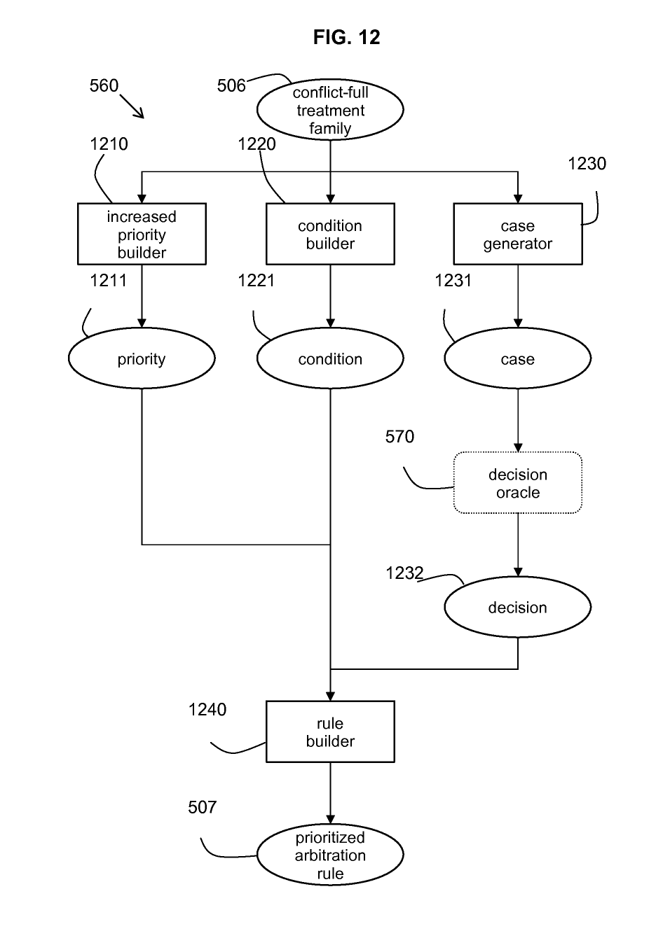

However, if the treatment-conflict checker 1107 does not detect any treatment free of conflicting decisions within the given family of treatments, in other words a conflict-full treatment family 506, then it send this family to the arbitration rule generator 560 shown in FIG. 12. As all treatments in the family have conflicting decisions and at least one treatment is on a top-level, the arbitration rule generator 560 creates an arbitration rule for resolving those conflicting decisions. A condition builder 1220 uses the logical tests in the description of this family to set up the condition 1221 of the arbitration rule. An increased priority builder 1210 puts the arbitration rule in a priority 1211 layer between the layer of the treatment and the next upper layer that occurs among the original rules. Finally, it uses a decision oracle 570 to produce a conclusion or action for the arbitration rule. The arbitration-rule generator 560 includes a case generator 1240 which supplies the decision oracle 570 with one or several cases 1231 treated by the arbitration rule and receives a description of the decision 1232 from the decision oracle 570. A rule builder 1240 uses this description to build the arbitration rule. The decision oracle 570 may be any decision-making procedure as elaborated in the fields of decision analysis and decision support, including but not limited to linear regression/discrimination, influence diagrams, Bayesian networks, outranking procedures, or include the intervention of a human expert. The arbitration-rule generator 560 then returns a prioritized most-general arbitration rule 507 as its result, which resolves conflicts among the rules beneath it.

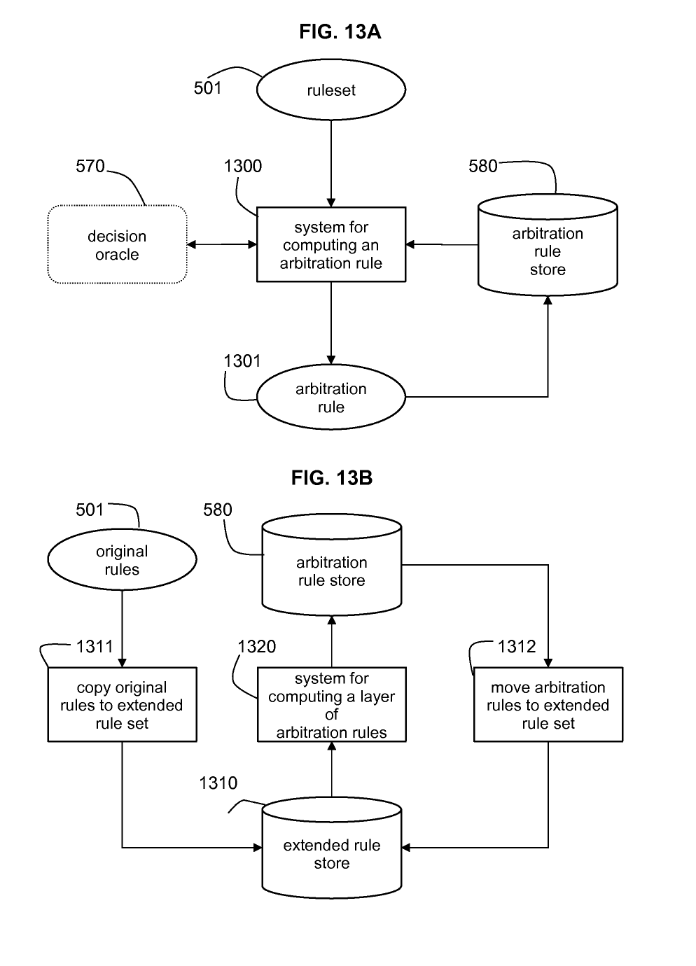

This completes the description of the system for generating a single arbitration rule. FIG. 13A shows how this system 1300 can be used to compute a layer of arbitration rules that resolves all conflicts among the given original rules 501. This enclosing system uses an arbitration rule store 580 to collect already generated arbitration rules. In each iteration, the system 1300 with use of the decision oracle 270 computes a new arbitration rule 1301, adds it to the store 580, and repeats this operation until no arbitration rule is returned any more. At this point, the arbitration rule store 280 contains a layer of arbitration rules that resolve all conflicts among the original rules.

FIG. 13B shows a system for resolving all conflicts among the rules, the generated arbitration rules included. It uses an extended rule store 1310 which is initialized by the original rules 501 by sending a copy 1311 of the original rules to the extended rule set in the extended rule store 1310. In each iteration, the overall system 1320 computes a layer of arbitration rules which for the extended rule store 1310. This layer resolves all conflicts among the rules in the extended rule store 1310, but not among the generated arbitration rules. The overall system therefore moves 1312 all arbitration rules from the arbitration rule store 580 to the extended rule store 1310, thus emptying the arbitration rule store 580. The arbitration rules thus change their status, meaning that there may be again conflicts among the rules in the extended rule store 1310. The overall system repeats the generation of layers of arbitration rules until no further arbitration rule is generated. At this point, all conflicts among the rules in the extended rule store 1310 have been resolved.

The invention can take the form of an entirely hardware embodiment, an entirely software embodiment or an embodiment containing both hardware and software elements. In an illustrative embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

As will be appreciated by one skilled in the art, aspects of the present invention may be embodied as a system, procedure or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of procedures, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational procedures to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, procedures and computer program products according to various embodiments of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Improvements and modifications can be made to the foregoing without departing from the scope of the present invention.

1. A method for computing prioritized, general arbitration rules for conflicting rules, comprising:
given a set of prioritized rules, considering a case having an applicable rule;
generalizing to a family of cases with conflicting rules of highest priority for the family cases;
generating an arbitration rule of higher priority; and
adding the arbitration rule to the set of prioritized rules.

2. The method of claim 1, including:
repeating the method until all conflicts are resolved.

3. The method of claim 1, including:
generating arbitration rules resolving conflicts among original rules in the set of prioritized rules; and
resolving conflicts among arbitration rules by adding additional priority layers until all conflicts are resolved.

4. The method of claim 1, wherein the set of prioritized rules includes original rules, any original arbitration rules, and any new arbitration rules.

5. The method of claim 1, wherein generalizing to a family of cases with conflicting rules of highest priority for the family cases includes:
lifting the case having an applicable rule to a top-most priority layer;
generalizing the case to a most-general family of cases with applicable rules; and
determining if the family contains any conflict-free cases and discarding any conflict-free cases.

6. The method of claim 1, including:
excluding any existing conflict-free cases when generating a case having an applicable rule.

7. The method of claim 1, wherein rules are condition-action rules or default rules, with fixed priorities or dynamic priorities.

8. The method of claim 7, wherein rules with dynamic priorities belong to several layers and calculating the priority of a rule depends on the case to which it is applied.

9. The method of claim 1, wherein
a first operation computes a single arbitration rule for a set of original rules, if previously generated arbitration rules are available, then this operation takes them into account and generate a new arbitration rule which is not among the previously generated arbitration rules;
a second operation iterates the computation of single arbitration rules in order to find a whole layer of arbitration rules, this layer of arbitration rules resolves all the conflicts among the original rules;
a third operation repeats the generation of layers of arbitration rules to remove any conflicts among the generated arbitration rules; in each iteration, the operation transforms the generated arbitration rules into original rules and reinvokes the second operation to compute a new layer of arbitration rules for this extended set of rules, while starting from an empty set of arbitration rules.

10. The method of claim 9, wherein the operations apply time limits to guarantee that the whole process terminates;
if such a time limit is exceeded, then the method will not find all arbitration rules, but the method guarantees that the computed rules are valid arbitration rules.

11. The method of claim 1, resulting in a stack of priority layers containing original rules as well as most-general arbitration rules.

12. The method of claim 1, wherein:
considering a case having an applicable rule has treatment in a layer if some rule applicable to the case is in the layer; and
wherein generalizing to a family of cases with conflicting rules of highest priority for the family cases includes:
a case having top-most treatment in a layer if there is no higher layer which has a treatment for this case;
a family of cases having a treatment in a layer if each case of the family has a treatment in the layer characterised by a set of logical tests;
a case family having a top-touching treatment in a layer if each case of the family has a treatment in this layer and at least one case in the family has a top-most treatment in this layer;
wherein top-most treatment models the fact that a rule engine selects an applicable rule in a highest priority layer.

13. The method of claim 1, wherein generating an arbitration rule is carried out by an external decision making method.

14. The method of claim 13, wherein the external decision making method inspects a set of cases treated by an arbitration rule and splits it, while imposing different decisions for the resulting rules.

15. A system for computing prioritized, general arbitration rules for conflicting rules, comprising:
a treatment generator for, given a set of prioritized rules, considering a case having an applicable rule;
a family generator for generalizing to a family of cases with conflicting rules of highest priority for the family cases;
an arbitration rule generator for generating an arbitration rule of higher priority and for adding the arbitration rule to the set of prioritized rules.

16. The system of claim 15, wherein the arbitration rule generator is for:
generating arbitration rules resolving conflicts among original rules in the set of prioritized rules; and
resolving conflicts among arbitration rules by adding additional priority layers until all conflicts are resolved.

17. The system of claim 15, further comprising a store of original rules and an arbitration rule store for any original arbitration rules and any new arbitration rules.

18. The system of claim 15, wherein the family generator further comprises:
a treatment-layer maximizer for lifting the case having an applicable rule to a top-most priority layer;
a treatment-case generalizer for generalizing the case to a most-general family of cases with applicable rules; and
a treatment-conflict checker for determining if the family contains any conflict-free cases and discarding any conflict-free cases.

19. The system of claim 15, further comprising a treatment nogood store for storing any conflict-free cases in order to exclude any existing conflict-free cases when generating a case having an applicable rule.

20. The system of claim 15, further comprising:
a system for computing an arbitration rule for carrying out a first operation computing a single arbitration rule for a set of original rules, if previously generated arbitration rules are available, then this operation takes them into account and generate a new arbitration rule which is not among the previously generated arbitration rules; and
a system for computing a layer of arbitration rules for carrying out:
a second operation iterating the computation of single arbitration rules in order to find a whole layer of arbitration rules, this layer of arbitration rules resolves all the conflicts among the original rules; and
a third operation repeating the generation of layers of arbitration rules to remove any conflicts among the generated arbitration rules; in each iteration, the operation transforms the generated arbitration rules into original rules and reinvokes the second operation to compute a new layer of arbitration rules for this extended set of rules, while starting from an empty set of arbitration rules.
